(19) United States
(12) Patent Application Publication
(10) Pub. No.: US 2026/0247392 A1
(43) Pub. Date: Aug. 20, 2026

(54) Data Delivery Control Management

(71) Applicant: Ofinno, LLC, Reston, VA (US)

(72) Inventors: SungDuck Chun, Fairfax, VA (US); Peyman Talebi Fard, Vienna, VA (US); Esmael Hejazi Dinan, McLean, VA (US); Henrik Andreas Normann, Malmö (SE); Kyungmin Park, Vienna, VA (US); Taehun Kim, Fairfax, VA (US); Jian Xu, McLean, VA (US); Stanislav Filin, Chantilly, VA (US); Oanyong Lee, Reston, VA (US)

(73) Assignee: Ofinno, LLC, Reston, VA (US)

(21) Appl. No.: 19/647,202

(22) Filed: Apr. 14, 2026

Related U.S. Application Data
(63) Continuation of application No. PCT/US2024/051570, filed on Oct. 16, 2024.
(60) Provisional application No. 63/544,855, filed on Oct. 19, 2023.

(51) Int. Cl. H04W 72/21

(52) U.S. Cl. CPC H04W 72/21

(57) ABSTRACT

A wireless device sends, to a base station on a satellite, a first message comprising a capability parameter indicating that the wireless device supports a store and forward (SF) mode. The wireless device receives one or more second messages including a feeder link information indicating a period when a feeder link of the satellite is available, a second parameter indicating that a network operates in the SF mode, and a third parameter indicating a supported time delay of an uplink data packet sent in the SF mode. The wireless device sends, to the base station and after receiving the one or more second messages, one or more third messages including a first uplink data packet sent in the SF mode, and a validity time information associated with the first uplink data packet sent in the SF mode.

### CROSS-REFERENCE TO RELATED APPLICATIONS

This application is a continuation of International Application No. PCT/US2024/051570, filed Oct. 16, 2024, which claims the benefit of U.S. Provisional Application No. 63/544,855, filed Oct. 19, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 is a diagram of an aspect of an example embodiment of the present disclosure.

FIG. 16 is a diagram of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

FIG. 24 is a diagram of an aspect of an example embodiment of the present disclosure.

FIG. 25 is a diagram of an aspect of an example embodiment of the present disclosure.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

FIG. 30 is a diagram of an aspect of an example embodiment of the present disclosure.

FIG. 31 is a diagram of an aspect of an example embodiment of the present disclosure.

FIG. 32 is a diagram of an aspect of an example embodiment of the present disclosure.

FIG. 33 is a diagram of an aspect of an example embodiment of the present disclosure.

FIG. 34 is a diagram of an aspect of an example embodiment of the present disclosure.

FIG. 35 is a diagram of an aspect of an example embodiment of the present disclosure.

FIG. 36 is a diagram of an aspect of an example embodiment of the present disclosure.

FIG. 37 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

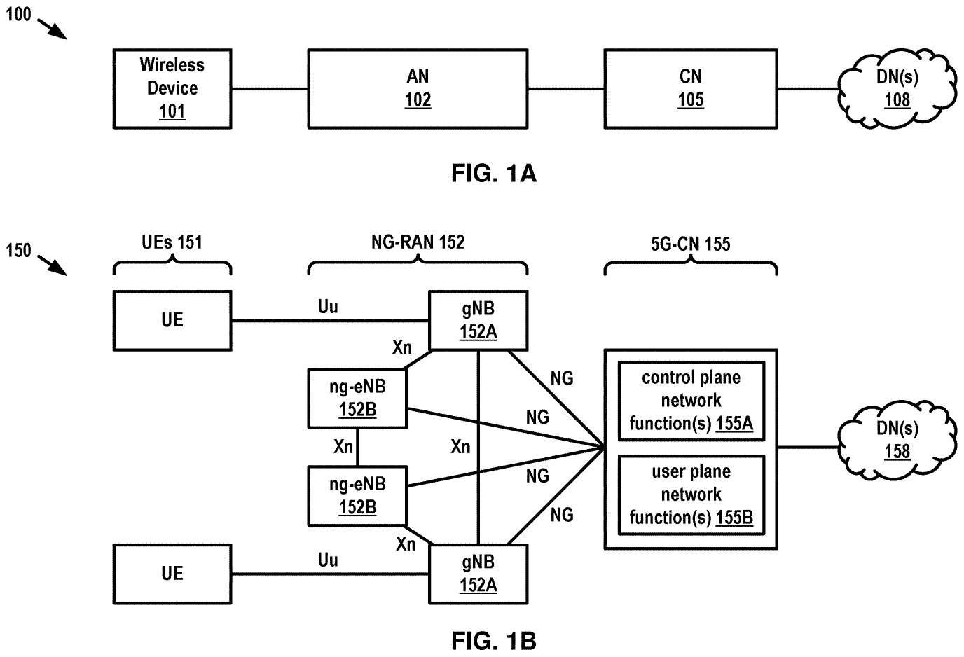

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

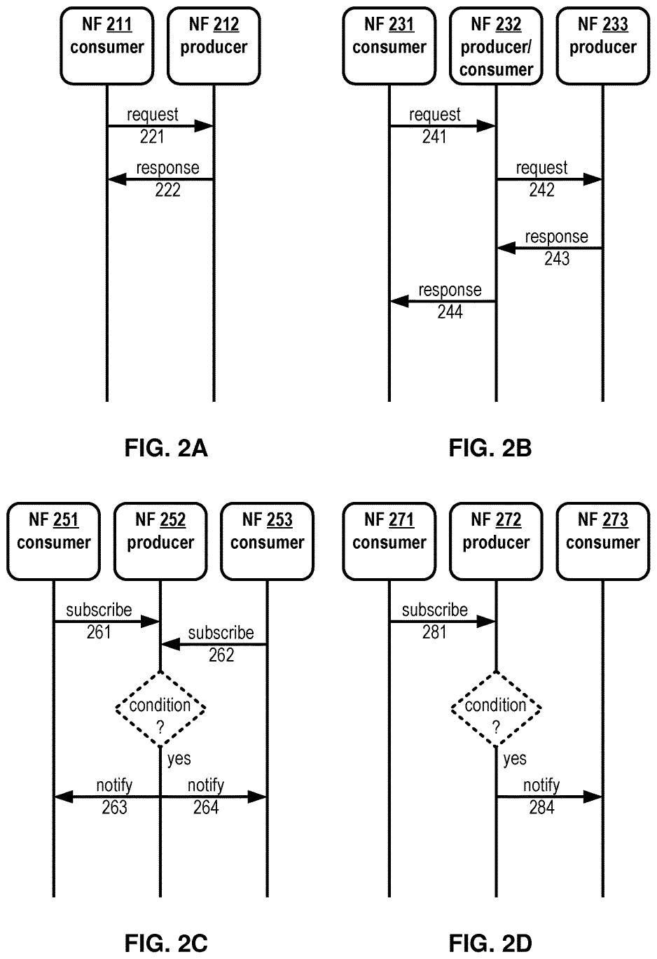

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

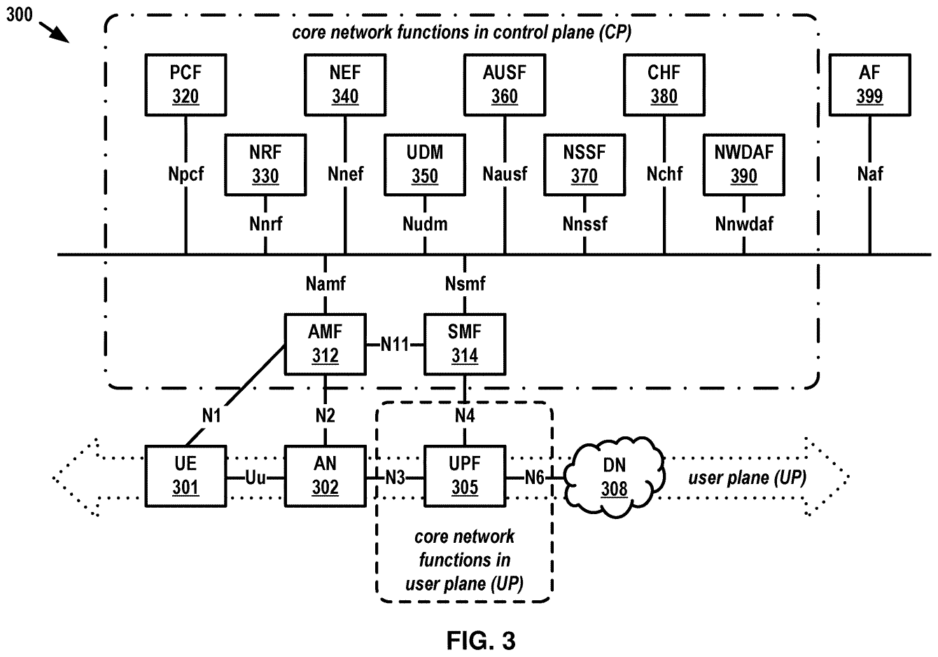

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

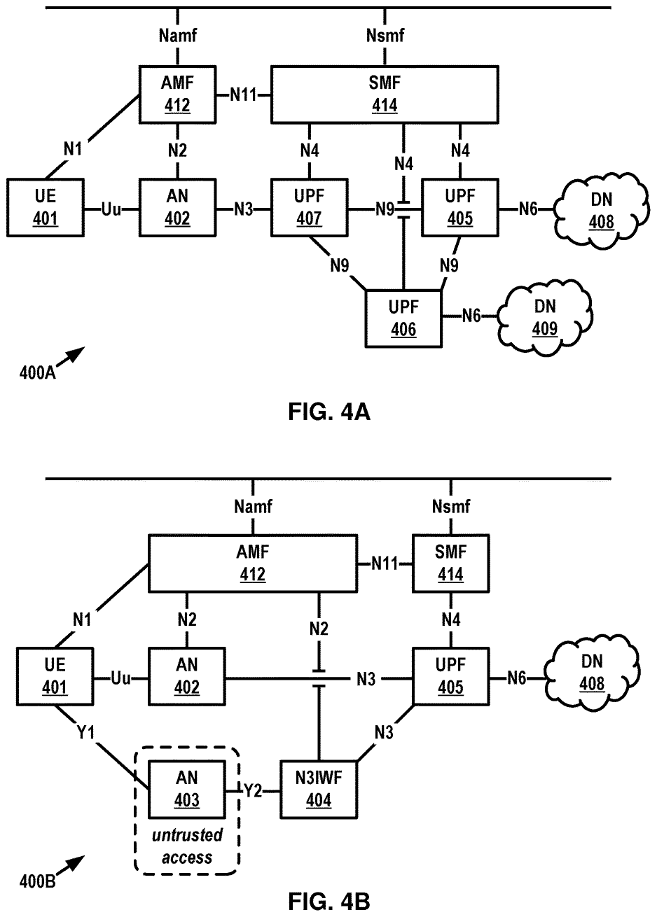

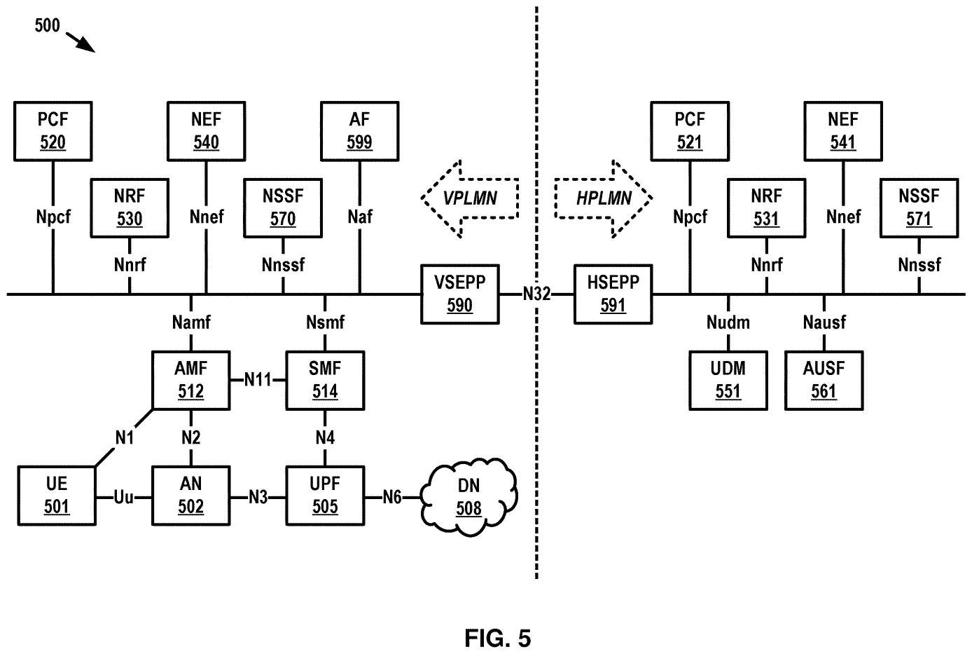

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

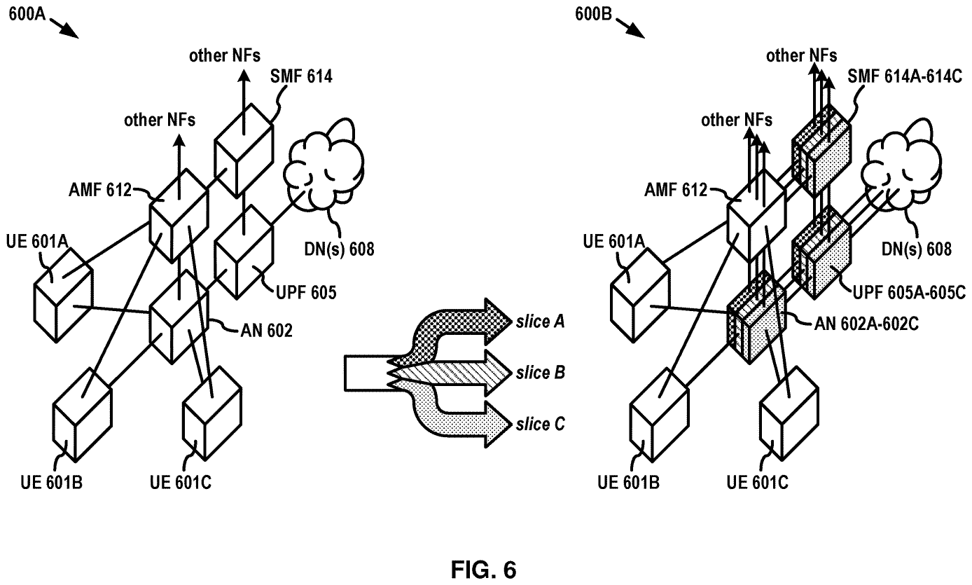

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

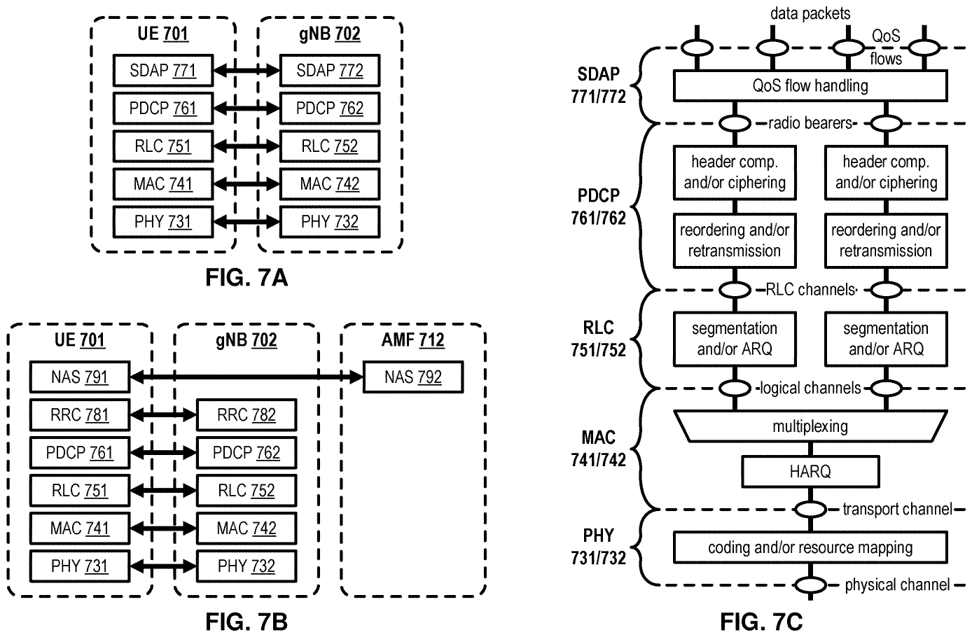

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

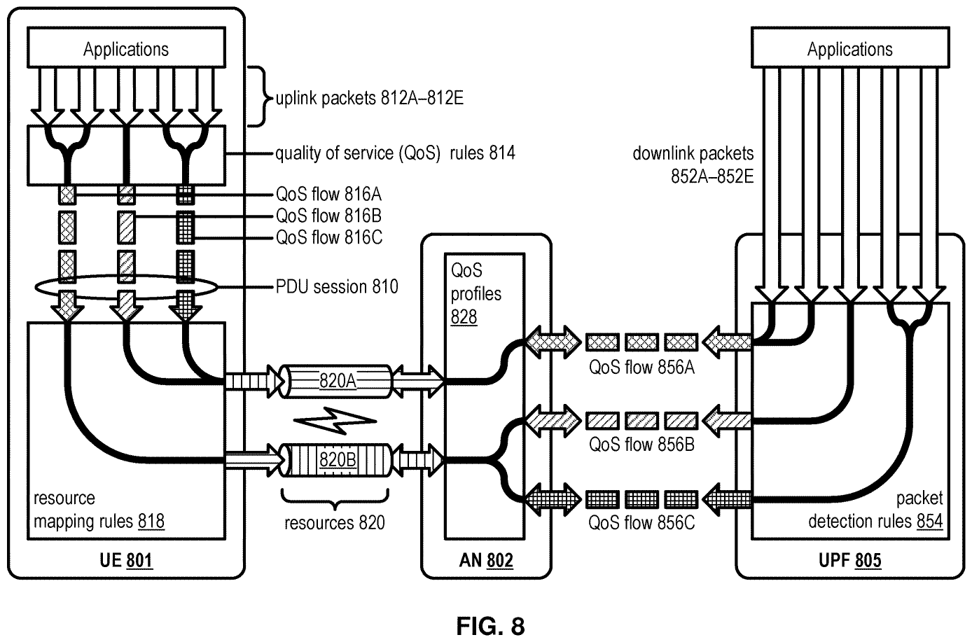

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

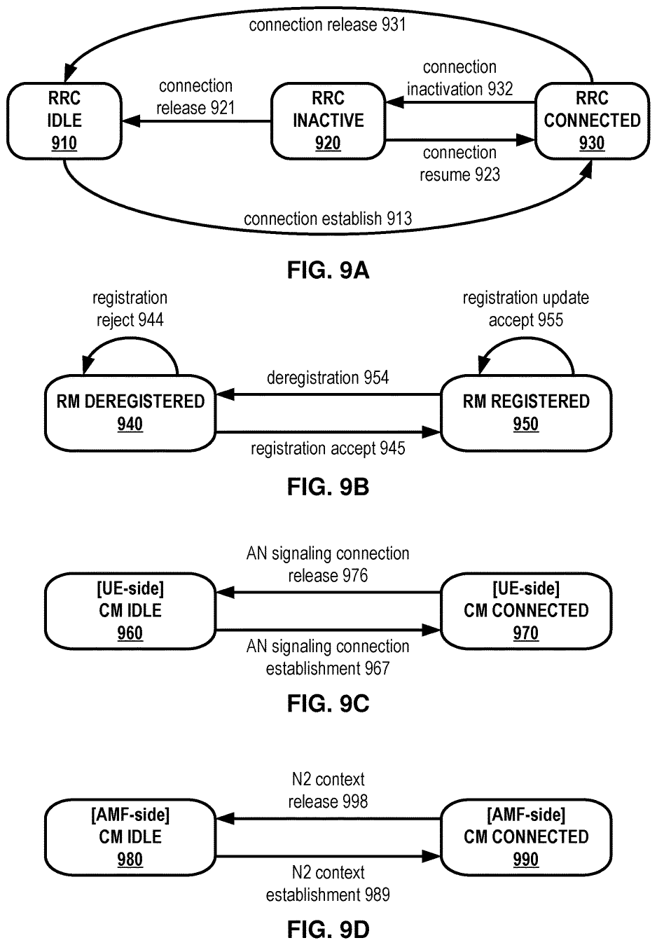

FIG. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF may release the N2 context of the UE (N2 context release 998).

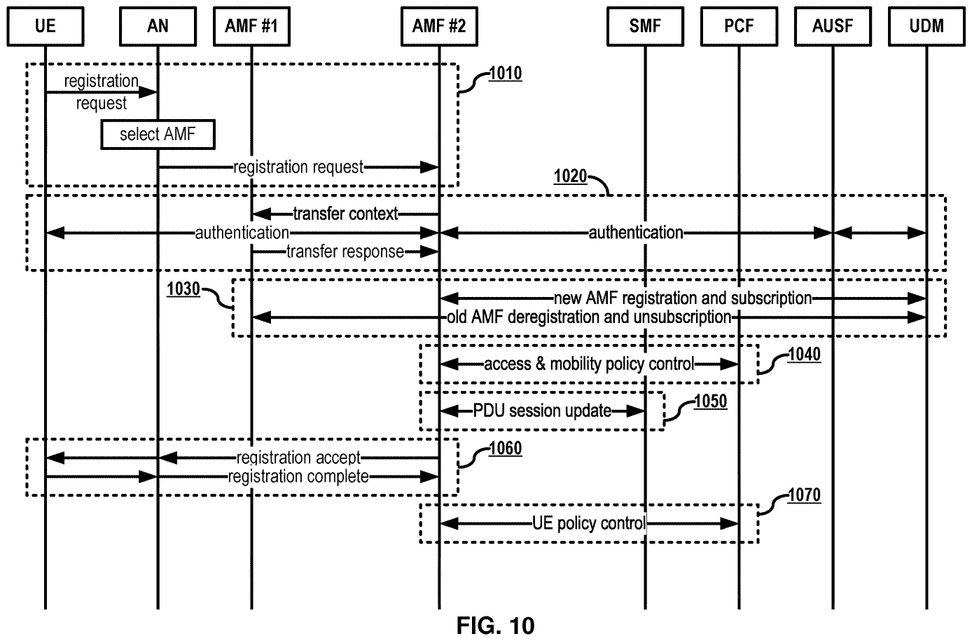

FIG. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF#1) into a coverage area of a new AMF (illustrated as AMF#2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF#2) performs a context transfer. The context may be a UE context, for example, an RRC context for the UE. As an example, AMF#2 may send AMF#1 a message requesting a context of the UE. The message may include the UE identifier. The message may be a Namf_Communication_UEContextTransfer message. AMF#1 may send to AMF#2 a message that includes the requested UE context. This message may be a Namf_Communication_UEContextTransfer message. After the UE context is received, the AMF#2 may coordinate authentication of the UE. After authentication is complete, AMF#2 may send to AMF#1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF#2, registers and/or subscribes with the UDM. AMF#2 may perform registration using a UE context management service of the UDM (Nudm_UECM). AMF#2 may obtain subscription information of the UE using a subscriber data management service of the UDM (Nudm_SDM). AMF#2 may further request that the UDM notify AMF#2 if the subscription information of the UE changes. As the new AMF registers and subscribes, the old AMF, AMF#1, may deregister and unsubscribe. After deregistration, AMF#1 is free of responsibility for mobility management of the UE.

At 1040, AMF#2 retrieves access and mobility (AM) policies from the PCF. As an example, the AMF#2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF#2 may update a context of a PDU session. For example, if the UE has an existing PDU session, the AMF#2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF#2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF#2. The registration complete message may acknowledge receipt of the new UE identifier and/or new configured slice identifier.

At 1070, AMF#2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

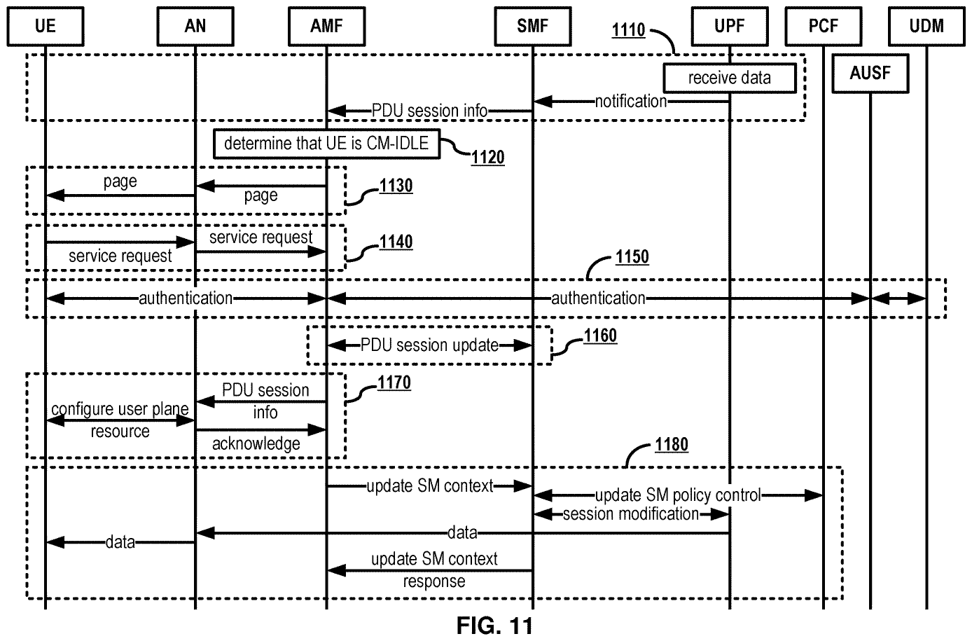

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

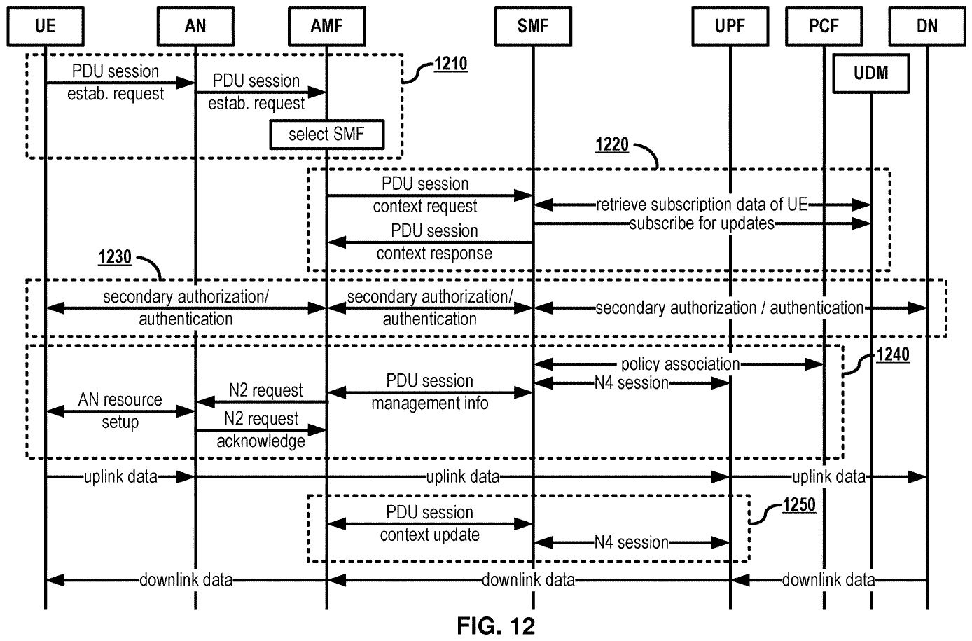

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

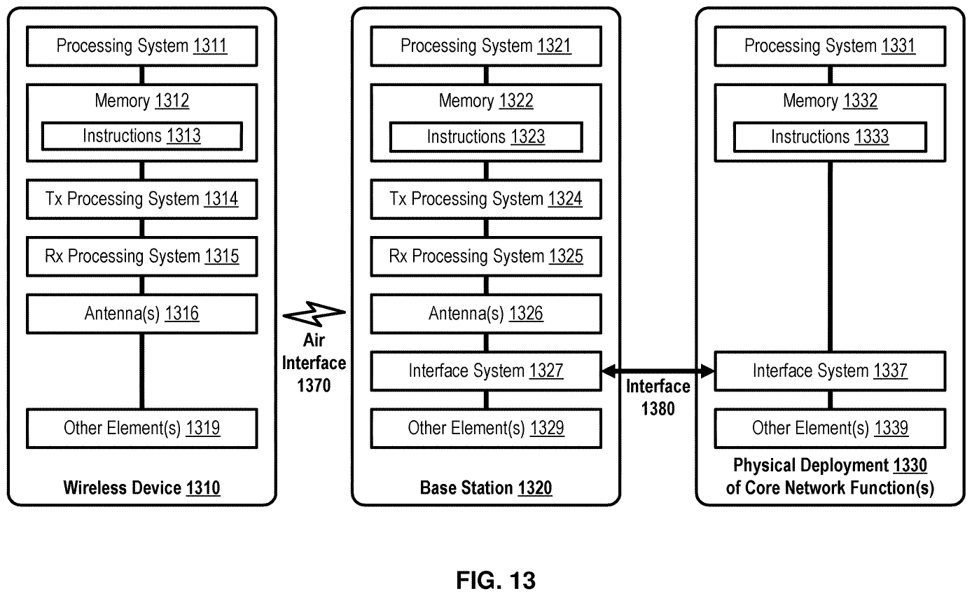

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab and/or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ and/or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

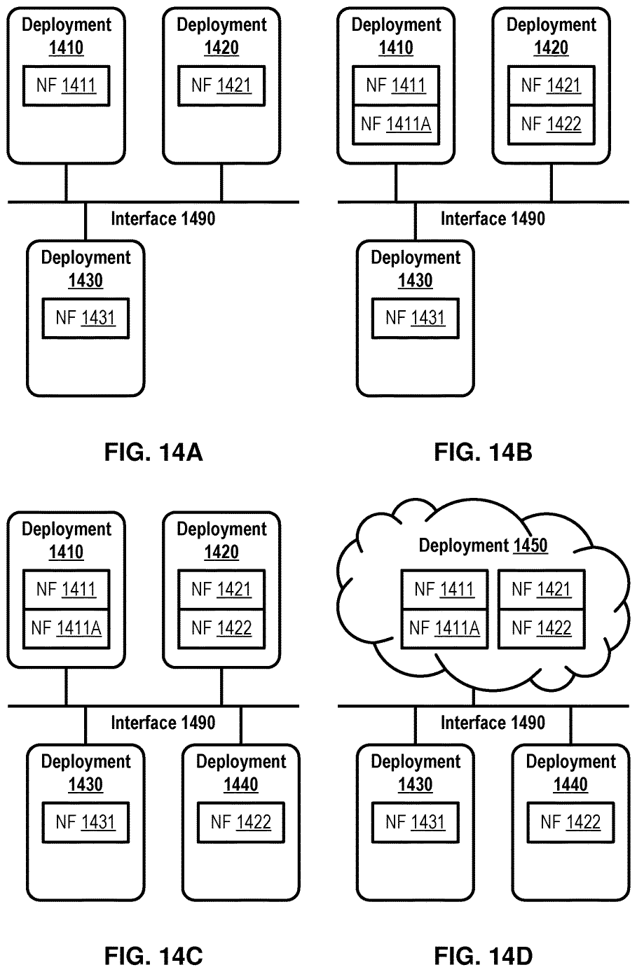

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

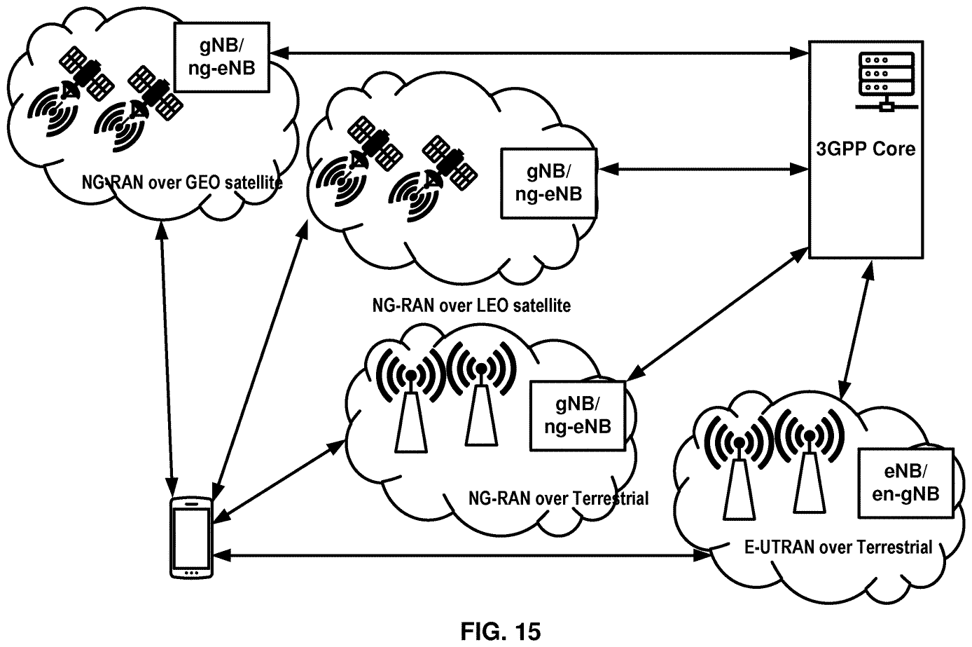

As 5G system (5GS) advances, 3GPP accesses may also advance, using different technologies covering expanded area. As shown in FIG. 15, one or more 3GPP RANs may be diversified and/or may be deployed in differentiated areas. An access node and/or a radio access network may be deployed as a terrestrial node (on the ground) or with similar frequencies (e.g., 2 Ghz). For example, the access node may be deployed on the ground, in the building and/or the like, and due to limitation of supported frequencies, may use similar frequency bands. As a result, there may not be much gain in differentiating 3GPP RANs on the ground. As 5G system equipment becomes smaller and signal of UEs with limited power become capable of reaching satellites, deploying one or more 3GPP access nodes (RANs, NG-RANs, E-UTRANs, 6G RANs) onto the satellites may become feasible. For example, a first RAN of the one or more 3GPP RANs may be deployed over a geostationary equatorial orbit (GEO). For example, a second RAN of the one or more 3GPP RANs may be deployed over a low earth orbit (LEO). For example, a third RAN of the one or more 3GPP RANs may be deployed as a terrestrial (e.g., on the ground, in the building) access network. For example, a fourth RAN of the one or more 3GPP RANs may be deployed as a terrestrial access network. These different 3GPP RANs may provide different characteristics. For example, the first RAN may provide coverage in a remote area where terrestrial 3GPP RANs cannot be deployed. For example, the second RAN may provide wider coverage than the terrestrial RAN, with a reduced throughput.

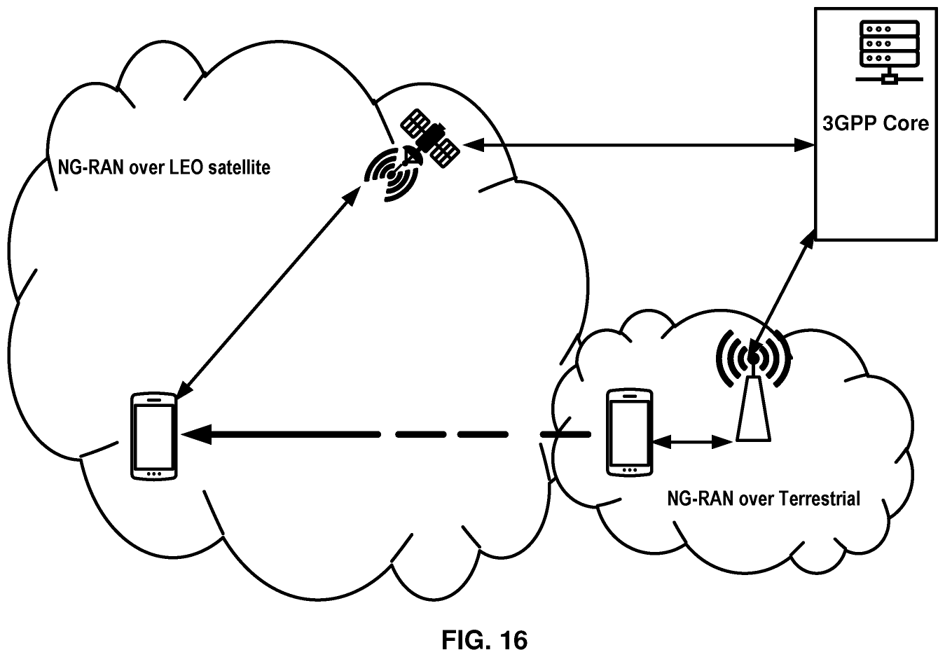

In an example as depicted in FIG. 16, a UE may benefit from using a RAN on a satellite. For example, initially, the UE may be in a first coverage provided by one or more first RANs. For example, the one or more first RANs may belong to a terrestrial RAN. The UE may send and/or receive one or more data packets via the one or more first RANs. Later, the UE may move toward edge of the one or more first RANs, may move out of the one or more first RANs, and/or may move into area where the first coverage by one or more terrestrial RANs is not available. In this case, a second coverage provided one or more second RANs may be available to the UE. For example, the one or more second RANs may be a satellite RAN (or NTN RAN). In this case, a communication path between the UE and a core network may be switched from the one or more first RANs to the one or more second RANs. This may support communication service continuity and may provide more communication availability to the UE.

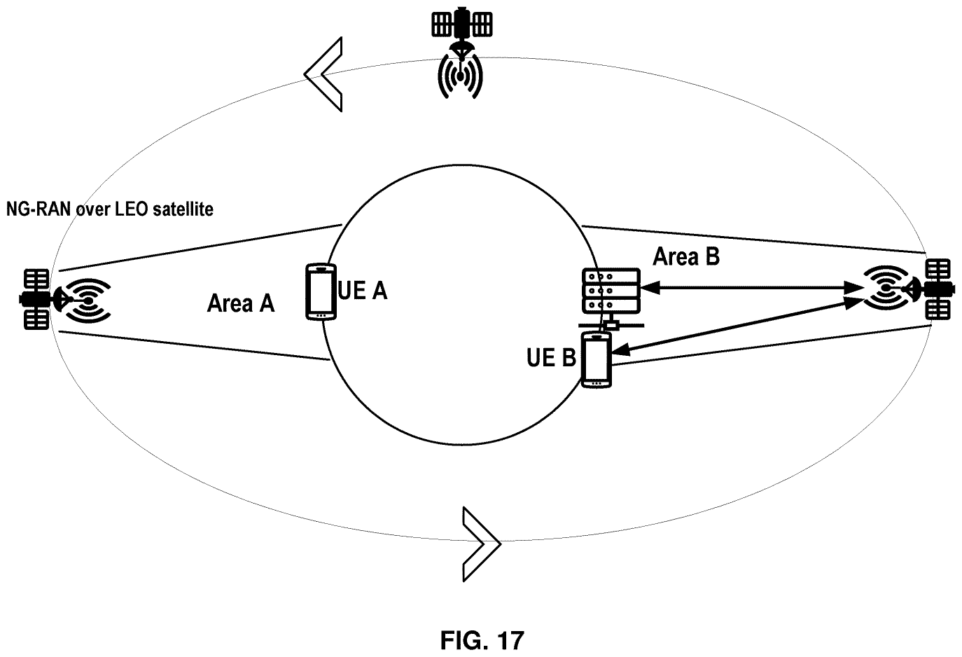

In an example as depicted in FIG. 17, a satellite may orbit around the Earth. Accordingly, a RAN on the satellite also may orbit around the Earth. As the RAN revolves around the Earth, an area covered by the RAN may also change. For example, at one or more first time occasions, the RAN may provide a first coverage to an area A, at one or more second time occasions, the RAN may provide a second coverage to an area B. For example, when the RAN provides the first coverage, a UE A located in the area A may send one or more data packets to the RAN. For example, when the RAN provides the second coverage, a UE B located in the area B may send one or more data packets to the NG-RAN.

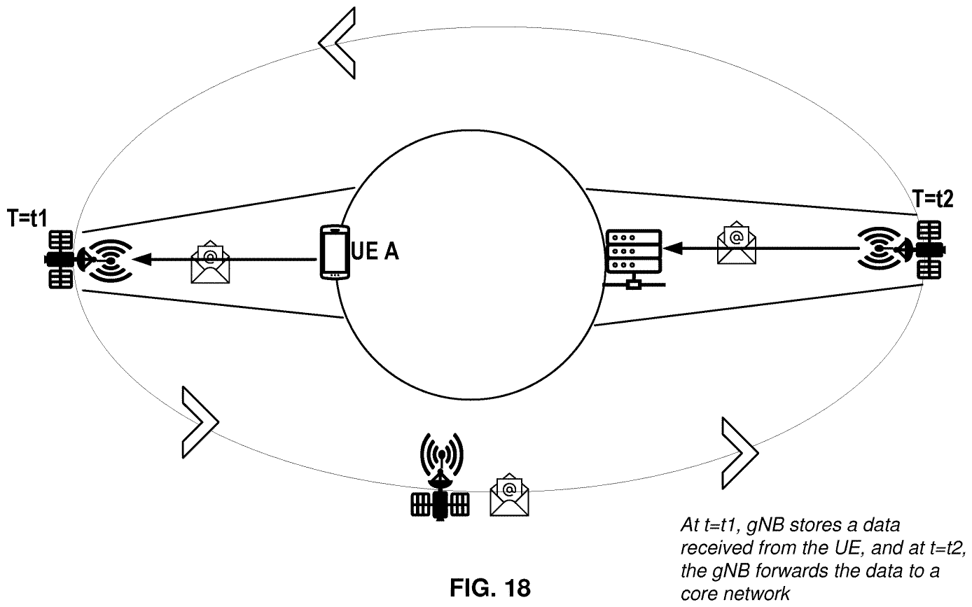

In an example, depending on location of the RAN, availability of a core network and/or a feeder link may be different. For example, if the core network is located in the area B, the RAN may be able to communicate with the core network, while the RAN is located over the area B. If the RAN is flying over the area B, the RAN may not be able to communicate with the core network. In this case, the UE A located in area A may not be able to send a first data packet to the core network. However, the UE B located in Area B may be able to send a second data packet to the core network. This may entail a store and forward, described in FIG. 18.

An example as depicted in FIG. 18 may help to allow data communication between a UE A in area A with a core network in area B, via a RAN on a satellite. For example, when the RAN flies over the area A where the UE A is located, the UE A may send a uplink data packet to the RAN. The RAN may store the received uplink packet from the UE A and may revolve the Earth. For example, the RAN may fly over to the area B where the RAN can connect to the core network. Then, the RAN may forward the stored uplink data packet to the core network. Similarly, when the RAN flies over the area B, the core network may send a downlink data packet to the RAN. The gNB may store the downlink data packet until it moves over to the area A. When the RAN flies over the area A, then the RAN may forward (e.g., send, transmit) the data to the UE in the area A. As described, using a store and forward mode, a first entity may be able to send/receive a data to/from a second entity which the first entity cannot communicate directly. However, the store and forward mode may incur another problem described below.

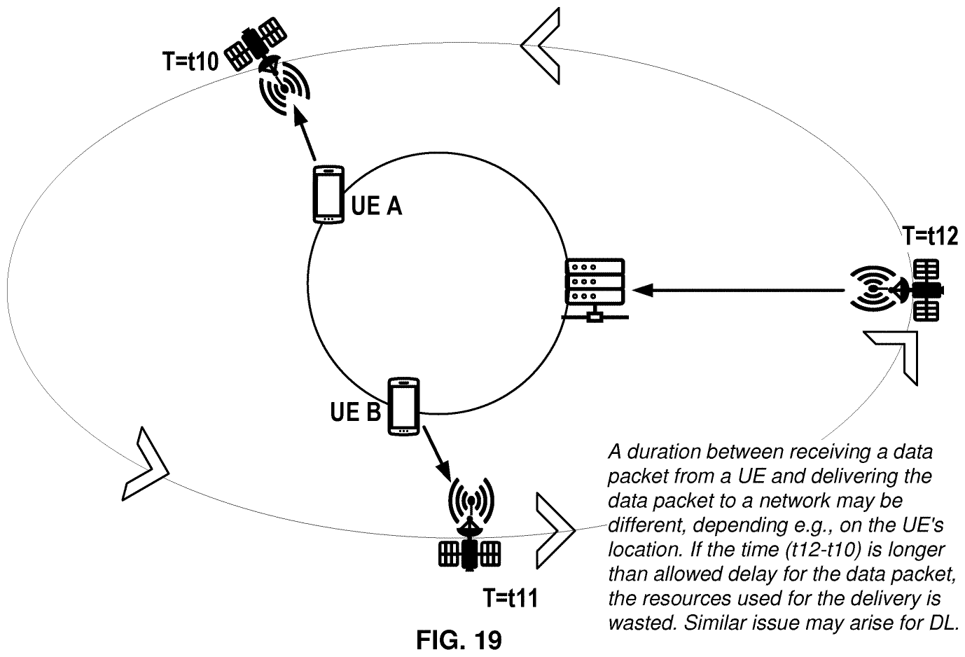

In an example depicted in FIG. 19, a RAN (e.g., onboard a satellite) may revolve around the Earth. At t=t10, the RAN may fly over a first location (where a UE A is located). The RAN may receive a first data sent by the UE A and/or the gNB may store the first data. At t=t11, the RAN may fly over a second location (where a UE B is located). The RAN may receive a second data sent by the UE B and may store the second data. At t=t12, the RAN may fly over a third location (where a core network is located, or where a feeder link is available). The RAN may forward one or more data (e.g., the first data, the second data) to the core network via the feeder link.

In an example, the first data may be a data for telemetry. For example, the telemetry data may be a gathered information for weather forecasting. Depending on an age of the telemetry data, a user (e.g., weather agency) may use the telemetry data or not. For example, a temperature measurement data at the first location may be useful for the weather agency (located in the third location), if the telemetry data is generated less than 1 hour ago. In this case, if a time duration (e.g., t12-t10) taken for the delivery of the data is more than 1 hour, the data delivered to the core network may not be useful and may just waste radio resources at the first location and/or at the third location.

In other example, an amount of data that can be delivered from the RAN to the core network may be limited. For example, a feeder link capacity when the RAN flies over the third location may be 1000 bytes. If a first size of the first data is 900 bytes and a second size of the second data is 800 bytes, either the first data or the second data may not be completely delivered to the core network. For example, the first data may be valuable up to 1 hours and/or the second data may be valuable up to 10 hours. In this case, at t=12, if the RAN forwards the second data to the core network, even if the RAN forwards the first data at later time (e.g., next time the RAN flies over the third area) successfully, the first data may not be no more useful to the weather agency. In existing technologies, when a data is communicated via a network node in a store and forward mode, the data may be delivered even when the data is not useful at an application. This may cause waste of radio resource in access link, and/or in feeder link. This may cause delivery delay of a time critical data, while delivering a non-time critical data.

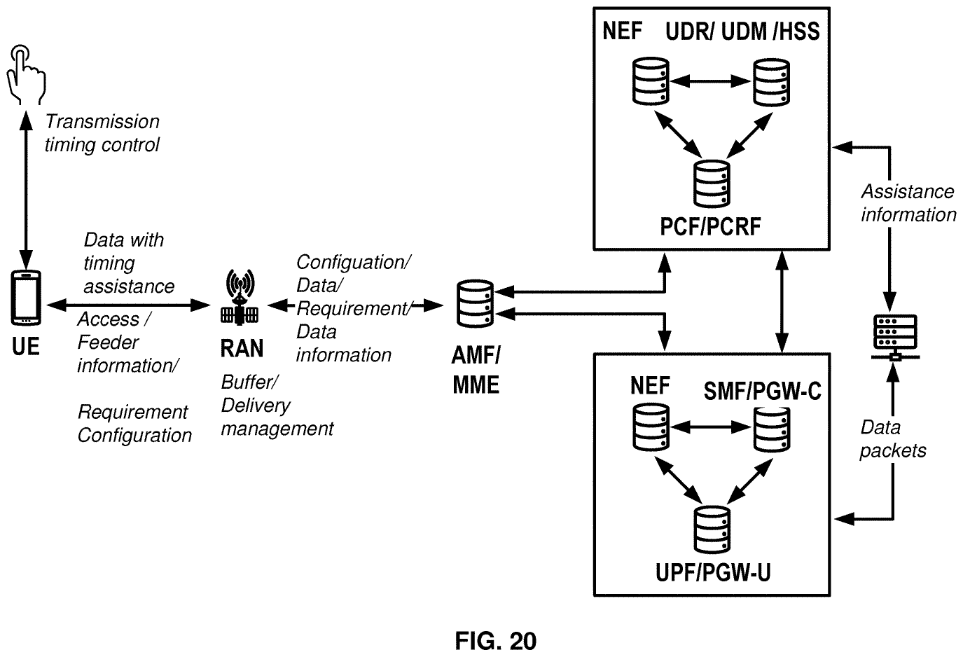

In examples of this disclosure, as shown in the FIG. 20, a signalling may be enhanced to exchange uplink time delay requirements, for one or more application, or for a store and forward mode. This may assist an application or a node to control whether to send data via a network node operating in the store and forward mode. In another example, a signalling may be enhanced to deliver a time assistance information. This may assist one or more nodes to determine whether to allocate resources for one or more data packets, whether to store the one or more data packets, whether to forward the one or more data packets, and/or whether to delete the one or more data packets from a buffer. In another example, one or more networks node may exchange information of an service (access) link and/or a feeder link. This may assist a network entity to determine whether data can be delivered within QoS time requirement and/or when to generate/send the data. In another example, an application layer may send information of timing requirement of the store and forward mode to a core network. This may assist the core network to configure one or more network entity to support the timing requirement, and/or to determine authorization of using the store and forward mode.

In the specification, the term “5G access network” may be interpreted as, or may refer to, an access network comprising at least one of a NG-RAN and/or non-3GPP AN, and connecting to a 5G core network.

In the specification, the term “5G core network” may be interpreted as, or may refer to, a core network connecting to a 5G access network. This may be 5G core (5GC).

In the specification, the term “3GPP RAN” or “RAN” may be interpreted as, or may refer to, a radio access network using 3GPP RAT. For example, this may comprise at least one of a gNB, an eNB, a ng-eNB, an en-gNB, the like, and/or a combination thereof. For example, this may be at least one of an E-UTRAN, NG-RAN, the like, and/or a combination thereof.

In the specification, the term “NG-RAN” may be interpreted as, or may refer to, a base station, which may comprise at least one of a gNB, a ng-eNB, a relay node, a base station central unit (e.g., gNB-CU), a base station distributed unit (e.g., gNB-DU), and/or the like. This may be a radio access network that connects to 5GC, supporting at least one of NR, E-UTRA, and/or a combination thereof.

In the specification, the term “E-UTRAN” may be interpreted as, or may refer to, a base station, which may comprise at least one of an eNB, an en-gNB, and/or the like. This may be a radio access network that connects to evolved packet core (EPC), supporting at least one of NR, E-UTRA, and/or a combination thereof.

In the specification, the term “NTN” may be interpreted as, or may refer to, a non-terrestrial network. For example, one or more first network nodes of the NTN may be on one or more satellites and/or one or more second network nodes of the NTN may be on the ground. At least one network node of the NTN may use a satellite access link to send and/receive a data with another network node of the NTN.

In the specification, the term “NTN RAN” may be interpreted as, or may refer to, a non-terrestrial network radio access network. For example, the NTN RAN may comprise at least one of a gNB onboard satellite, an eNB onboard satellite, a gNB-DU onboard satellite, a gNB-CU onboard satellite, and/or the like. For example, the NTN RAN may comprise a NG-RAN onboard satellite, a E-UTRAN onboard satellite, a 3GPP RAN onboard satellite.

In the specification, the term “access link” may be interpreted as an interface between a UE and a satellite. For example, when a satellite comprises a RAN, the access link may comprise Uu interface (or link) between the UE and the satellite. In an example, the access link may be a service link. For example, when a UE transmits a signal over the access link, the RAN may receive the signal over the access link. For example, when a UE transmits a signal to a satellite over the access link, the satellite may receive the signal over the access link.

In the specification, the term “feeder link” may be interpreted as an interface between a ground station and a satellite. For example, the satellite may have two links (interfaces). A first link of the two links may be the access link which is interface between the satellite and the UE, and a second link of the two links may be the feeder link which is interface between the satellite and an earth station which relays messages/signal between the satellite and the ground node. In other example, the first link of the two links may be used for communication between the satellite and the UE, and the second link of the two links may be used for communication between the satellite and a network (e.g., a RAN, a core network) (and/or via the earth station). For example, when a RAN is onboard, N2 interface and/or N3 interface may be implemented over the feeder link. In an example, the feeder link may be a backhaul link.

In the specification, the term “network node” may be interpreted as, or may refer to, at least one of a core network node, an access node, a UE, the like, and/or a combination thereof. A network may comprise one or more network nodes.

In the specification, the term “core network node” may be interpreted as, or may refer to, a core network device, which may comprise at least one of an AMF, a SMF, a NSSF, a UPF, a NRF a UDM, a PCF, a SoR-AF, an AF, an DDNMF, an MB-SMF, an MB-UPF, a MME, a SGW, a PGW, a SMF+PGW-C, a SMF+PGW-U, a UDM+HSS and/or the like.

In the specification, the term “store and forward (SF or S&F) mode” may be interpreted as, or may refer to, an operation in which information is sent to an intermediate station where it is kept and sent at a later time to a final destination or to another intermediate station. For example, the SF mode may comprise at least one of uplink SF mode and downlink SF mode. For example, the uplink SF mode may comprise at least one of sending by a UE a data, receiving by a RAN the data, storing by the RAN the data, forwarding the by RAN the data to a core network. For example, the downlink SF mode may comprise at least one of, receiving by a first core network node a data, storing by a second core network the data, forwarding by the second core network node the data to a RAN, receiving by the RAN the data, storing by the RAN the data, forwarding by the RAN the data to a UE. For example, the SF mode may be used when a RAN (e.g., gNB, eNB) orbits around the earth, and/or when at least one of an access link or an feeder link is not available to the RAN sometimes. The SF mode may be a store and forward (S&F or SF) satellite operation. For example, the SF satellite operation (or a SF satellite operation mode, SF mode, SF operation mode) may provide communication service (in storing and forwarding information) to a UE, in periods of time and/or geographical areas in which a serving satellite is not simultaneously connected to the ground network via the feeder link or the ISL (inter satellite link). For a case of UL, a “store” refers to on-board storage of UL information (e.g., UL data packet, signalling) from the UE and “forward” may refer to forwarding of the stored UL information to the ground network (e.g., to a core network node, via an earth station). For a case of DL, “store” may refer to on-board storage of DL information (e.g., a downlink data packet, signalling) received from the ground network, or storage of the DL information in a core network until the feeder link is available, and “forward” may refer to forwarding of the stored DL information to the UE. A node supporting a feature of the SF mode, may be able to process information associated with the SF mode, to interpret information associated with the SF mode, to buffer a data for the SF mode, to send information associated with the SF mode, to receive information associated with the SF, and/or the like.

For example, one or more nodes (e.g., a UE, a network node, a RAN) may operate in at least one of normal/default satellite operation (e.g., non-S&F operation mode) or S&F satellite operation. Under “normal/default Satellite operation” mode, signalling and data traffic exchange between a UE with satellite access and a ground network may require a service link and a feeder link to be active simultaneously, so that, at the time that the UE interacts over the service link with a satellite, there is a continuous end-to-end connectivity path between the UE, the satellite and the ground network. Under “S&F Satellite operation” mode, end-to-end exchange of signalling/data traffic may be handled as a combination of two steps not concurrent in time. In first step, signalling/data exchange between the UE and the satellite may take place, without the satellite being simultaneously connected to the ground network (i.e., the satellite is able to operate the service link without an active feeder link connection). In second step, connectivity between the satellite and the ground network may be established so that communication between the satellite and the ground network can take place.

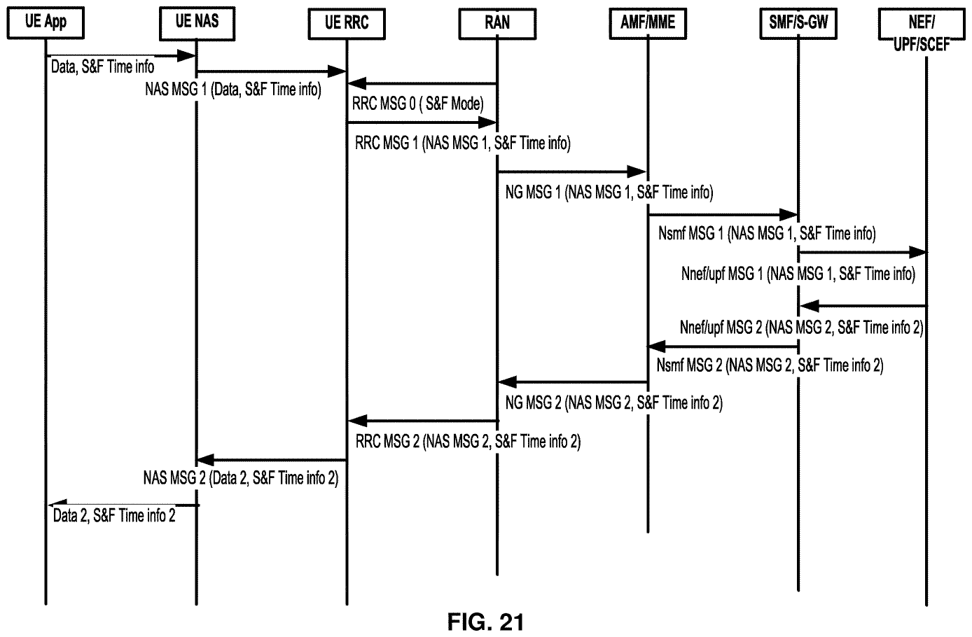

FIG. 21 depicts one example embodiment of the present disclosure. In an example, when a UE sends an uplink data packet, the UE may send a time information of the uplink data packet with the uplink data packet. This may help a network node to determine whether to store the uplink data packet, whether to forward the uplink data packet. Similar mechanism may be used for a downlink data packet. For brevity, based on the other part of the present disclosure, redundant details will be omitted.

In an example, an application of an application layer may generate the uplink data packet. For example, the application layer may be co-located in the UE, or may be attached to the UE. The application may send (e.g., deliver) the uplink data packet to a NAS entity (or NAS layer) of the UE. In an example, the application may send the uplink data packet with a first S&F time information. For example, a first S&F time information may comprise at least one of:
a first value indicating a first time when the uplink data packet is generated (e.g., created) by the application.
a second value indicating a second time when the UE (e.g., the NAS entity) receives the uplink data packet from the application or when the NAS entity generates a NAS MSG (e.g., a NAS MSG 1).
a third value indicating a third time when the UE (e.g., a RRC entity (or a NAS entity) of the UE) sends the uplink data packet to a network node (e.g., a gNB, an eNB, a satellite).
a fourth value indicating a fourth time duration during which the uplink data packet stays at the UE. For example, if the UE receives the uplink data packet at 10:00 from the application, and the UE sends the uplink data packet to a RAN at 10:05, the time difference (e.g., 10:05-10:00=5 minutes) is the fourth time duration during which the uplink data packet stays at the UE. For example, the fourth time duration may indicate an amount of time the uplink data packet spends in the UE, before being delivered (transmitted) to a next node (e.g., gNB, eNB).
a fifth value indicating a fifth time until when the uplink data packet is valid. For example, this may indicate a time from when there is no need to forward (e.g., deliver) the uplink data packet. For example, if this indicates AM 11:03, after this time (e.g., after AM 11:03), intermediate nodes (e.g., the UE, the RAN, the core network) may not be required to deliver the uplink data packet.
a sixth value indicating a sixth time when the uplink data packet expires. For example, this may indicate a time from which a content of the uplink data packet is not valid anymore or a time when delivering of the uplink data packet is stopped (or terminated). For example, if this indicates AM 09:02, the contents of the uplink data packet may be valid only before AM 09:02.
a seventh value indicating a seventh time duration during which a RAN can store the uplink data packet. For example, this may indicate a maximum time during which the RAN (or a subsequent nodes) is allowed to store the uplink data packet. For example, if this indicates 30 minutes, the RAN may not store the uplink data packet more than 30 minutes after receiving or, the RAN may discard the uplink data packet after the 30 minutes after receiving the uplink data packet. This may indicate a remaining delay budget (time) for the delivery of the uplink data packet. For example, this may indicate that the uplink data packet should be delivered in 30 minutes to the application (application server).

In an example, the NAS entity (e.g., layer) of the UE may construct a NAS MSG 1 (e.g., first NAS message). For example, the NAS MSG 1 may comprise the uplink data packet and/or a second S&F (e.g., store and forward) time information. For example, the NAS MSG 1 may be at least one of a registration request message, a UL NAS transport message, a service request message, a control plane service request message, and/or the like. For example, the second S&F time information may be the first S&F time information. For example, the NAS entity may construct (or modify) the second S&F time information based on the first S&F time information. For example, a remaining time indicated by the second S&F time information may be smaller than a remaining time indicated by the first S&F time information, considering a time spent in the NAS entity. Similar adjusting may be applied for other information of the S&F time information, in other S&F time information by other entity (node). The NAS entity may deliver to the RRC entity (of the UE) and/or the second S&F time information. For example, the NAS entity and/or the UE may determine to use a control plane IoT (CIoT) optimization, and/or may determine to send the uplink data packet via a control plane. For example, the NAS entity may be a MM (mobility management) layer, a SM (session management) layer. For example, when the control plane is not used for delivery of the uplink user data, the uplink user data may be delivered from the application to a PDCP entity, and may not use the MM layer, the SM layer, and/or the RRC layer.

In an example, the RRC entity may receive a RRC MSG 0, from a cell of the RAN (e.g., an eNB, a gNB, a 3GPP radio access node, a satellite). For example, the RAN may be a NTN RAN. For example, the RAN may operate in the S&F mode or may activate the S&F mode. The RRC MSG 0 may comprise an indication that the RAN (or the cell) operates in the S&F mode, and/or that the RAN is onboard satellite. The RRC MSG 0 may be a SIB message or may be a dedicated RRC message to the UE. The UE may receive the RRC MSG 0. Based on the indication that the RAN operates in the S&F mode, the UE may determine that the RAN operates in the S&F mode.

In an example, the RRC entity may receive the NAS MSG 1 from the NAS entity. In response to receiving the NAS MSG 1, the RRC entity may construct a RRC MSG 1. For example, the RRC MSG 1may comprise at least one of the NAS MSG 1, a third S&F time information. For example, the third S&F time information may be the second (or the first) S&F time information. For example, the RRC entity may construct (or modify) the third S&F time information based on the second (or the first) S&F time information. For example, the RRC MSG 1 may be at least one of a RRC Setup Request message, a RRC Resume request message, a RRC Setup complete message, a RRC resume complete message, a UL RRC transport message, and/or the like. For example, the RRC entity may include the third S&F time information, if the UE operates in S&F mode, if the UE is authorized for S&F mode, and/or if the RAN operates in S&F mode. In other example, the RRC entity may not include the third S&F time information, if the UE does not operate in S&F mode, if the UE is not authorized for S&F mode, and/or if the RAN does not operate in S&F mode. For example, the UE may operate in S&F mode if the UE receives authorization for S&F mode from a network.

In an example, the RAN may receive the RRC MSG 1. For example, if the RAN operates in the S&F mode, and/or if a feeder link is not available, the RAN may store in its memory, the NAS MSG 1 of the RRC MSG 1 and/or the third S&F time information of the RRC MSG 1 (or the NAS MSG 1).

In an example, the RAN may send a NG MSG 1 to a first core network node (e.g., MME, AMF, and/or the like). For example, when the feeder link is available, the RAN may send a NG MSG 1 to the first core network node. For example, the NG MSG 1 may be at least one of the NG MSG 1 may be initial UE message, UL Transport message, S1AP initial UE message, S1AP uplink data transfer, Path Switch message, and/or the like. The NG MSG 1 may comprise at least one of the NAS MSG 1, a fourth S&F time information, and indication that the RAN operates in the S&F mode. For example, the fourth S&F time information may be the third S&F time information. For example, the RAN may construct (or modify) the fourth S&F time information based on the third S&F time information. For example, the fourth S&F time information may comprise at least one of:
one or more values of the first (or second, third) S&F time information;
a eighth value indicating an eighth time when the uplink data packet is received by the RAN.
a nineth value indicating a nineth time duration during which the uplink data packet is stored by the RAN, before being forwarded to a core network. This may further include the time spent in the UE.
tenth value indicating a tenth time duration during which a core network needs to forward (deliver) the uplink data packet to the application server. For example, this may indicate a maximum time during which the core network is allowed to store and to forward the uplink data packet. For example, if this indicates 15 minutes, and the core network may not store the uplink data packet more than 15 minutes or, the core network may need to deliver the uplink data packet in 15 minutes or the core network may discard the uplink data packet after the 15 minutes. This may indicate a remaining delay budget for the delivery of the uplink data packet. For example, this may indicate that the uplink data packet should be delivered in 15 minutes by the core network.

In an example, the first core network node may receive the NG MSG 1, when the feeder link is available.

In an example, in response to receiving the NG MSG 1, the first core network node may send a Nsmf MSG 1 to a second core network node (e.g., SMF, S-GW, P-GW, SCEF). For example, the Nsmf MSG 1 may comprise at least one of the NAS MSG 1, one or more information element of the NAS MSG 1, a fifth S&F time information, and/or the like. For example, the fifth S&F time information may be the fourth S&F time information. For example, the first core network node may construct (or modify) the fifth S&F time information based on the fourth S&F time information. For example, the first Nsmf message may be at least one of first Nsmf_PDUSession_Create request, first Nsmf_PDUSession_Update request, first Nsmf_PDUSession_CreateSMContext request, first Nsmf_PDUSession_UpdateSMContext request, Create session request, modify session request, S11U GTPU message transfer, and/or the like.

In an example, the second network node may receive the Nsmf MSG 1.

In an example, in response to receiving the Nsmf MSG 1, the second core network node may send a Nnef MSG 1 (or Nupf MSG 1, or N4 MSG 1, S11 MSG 1, and/or the like) to a third core network node (e.g., NEF, UPF). For example, the Nnef MSG 1 may comprise at least one of the NAS MSG 1, one or more information element of the NAS MSG 1, a sixth S&F time information, and/or the like. For example, the sixth S&F time information may be the fifth S&F time information. For example, the second core network node may construct (or modify) the sixth S&F time information based on the fifth S&F time information. For example, the sixth S&F time information may indicate a time when the first core network node receives the uplink data packet, a time duration during which the uplink data packet spends in the network, and/or the like.

In an example, the third core network node may receive the Nnef MSG 1. For example, the third core network node may receive the uplink data packet via the Nnef MSG 1. The third core network node may deliver the uplink data packet to an application server. For example, the third core network node may additionally send with the uplink data packet, a seventh S&F time information, an indication indicating that the uplink data packet is delivered using the S&F mode. For example, the seventh S&F time information may indicate at least one of whether the S&F mode is used, when the uplink data packet is received by the RAN, when the uplink data packet is received by the core network, how long the uplink data packet is stored by the RAN, how long the uplink data packet is stored by the core network, how long the uplink data packet spend time in the network, how much time takes for the uplink data packet to be delivered from the UE to the application server, how much time takes for the network to deliver the uplink packet, and/or the like.

In other example, a downlink data packet may arrive at the third core network node. The third core network node may send a Nnef MSG 2 (or Nupf MSG 2, or N4 MSG 2, or a SCEF message, S11 message, and/or the like) to the second core network. For example, the Nnef MSG 2 may comprise at least one of the downlink data packet, one or more information (e.g., the downlink data packet) of a NAS MSG 2, a seventh S&F time information, and/or the like. The downlink data packet may be delivered by the control plane. For example, when the control plane is used for the data delivery, the downlink data packet arriving at the NEF (e.g., SCEF) and/or the UPF (P-GW, S-GW) may be forwarded to the SMF (e.g., P-GW, S-GW, MME). For example, the seventh S&F time information may comprise at least one of:
a 11^{st} value indicating an 11^{st} time when the downlink data packet is received by the network (e.g., NEF, UPF, SCEF, an edge core network node, P-GW, and/or the like)
a 12^{nd} value indicating an 12nd time duration during which the downlink data packet can be stored in the network, maximum packet delay budget of the downlink data packet.
a 13^{rd} value indicating an 13rd time when the downlink data packet expires, or is no more valid, or the network can discard the downlink data packet. For example, the 13rd value may indicates a maximum time delay, a maximum packet delay budget for the downlink data packet.
a 14^{th} value indicating a 14^{th} time duration indicating how long the downlink data packet is stored at the third core network node before being delivered to the second core network. Or, this may be an accumulated value comprising time spent in previous network nodes.
a 15^{th} value indicating a 15^{th} time duration indicating a remaining amount of time until when the downlink data packet needs to be delivered to the UE. This may indicate a time that all subsequent network nodes can use together.

In an example, the second core network node may receive the Nnef MSG 2.

In an example, in response to receiving the Nnef MSG 2, the second core network node may send a Nsmf MSG 2 to the first core network node. For example, the Nsmf MSG 2 may comprise at least one of the downlink data packet, one or more information element of the NAS MSG 2, an eighth S&F time information, and/or the like. For example, the eighth S&F time information may be the seventh S&F time information. For example, the second core network node may construct (or modify) the eighth S&F time information based on the seventh S&F time information. For example, based on the amount of time the downlink data packet spends in the second core network node, the one or more values of the seventh S&F time information may be adjusted before being used for the eighth S&F time information.

In an example, the first core network node may receive the Nsmf MSG 2.

In an example, in response to receiving the Nsmf MSG 2, the first core network node may send a N2 MSG 2 to the RAN. For example, the first core network node may send the N2 MSG 2 if the feeder link is available. For example, the N2 MSG 2 may comprise at least one of the downlink data packet, the NAS MSG 2, a ninth S&F time information, and/or the like. For example, the ninth S&F time information may be the eighth S&F time information. For example, the first core network node may construct (or modify) the ninth S&F time information based on the eighth S&F time information. For example, based on the amount of time the downlink data packet spends in the first core network node, the one or more values of the eighth S&F time information may be adjusted before being used for the ninth S&F time information.

In an example, the RAN may receive the N2 MSG 2.

In an example, in response to receiving the N2 MSG 2, the RAN may send a RRC MSG 2 to the UE. For example, the RAN may send the RRC MSG 2 if the access link is available. Or, the RAN may store the content (e.g., the NAS MSG 2 or the downlink data packet) of the N2 MSG 2 until the access link is available. For example, the RRC MSG 2 may comprise at least one of the downlink data packet, the NAS MSG 2, a tenth S&F time information, and/or the like. For example, the tenth S&F time information may be the ninth S&F time information. For example, the RAN may construct (or modify) the tenth S&F time information based on the ninth S&F time information. For example, based on the amount of time the downlink data packet spends in the RAN, the one or more values of the ninth S&F time information may be adjusted before being used for (or set to) the tenth S&F time information. For example, the ninth S&F time information may indicate that the remaining time for delivery of the downlink data packet is 30 minutes. If the RAN stores the downlink data packet for 10 minutes before delivering the downlink data packet to the UE, the remaining time may be adjusted (e.g., 30−10=20 minutes). The tenth S&F time information may indicate the adjusted remaining time (e.g., 20 minutes). This adjustment may be perform at each network node.

In an example, the UE (e.g., the RRC entity) may receive the RRC MSG 2. The RRC entity may forward the NAS MSG 2 of the RRC MSG 2 to the NAS entity. For example, the RRC entity may forward the tenth S&F time information. The NAS entity may receive the NAS MSG 2 and/or the tenth S&F time information. The NAS entity may forward the downlink data packet with the tenth S&F time information to the application. This may help the application to determine how long delivery of the downlink data packet takes or how long the network spends for the delivery.

In an example, each S&F time information may comprise accumulated time information, indicating total time spent (used, consumed) for delivery of an associated packet. For example, using the tenth S&F time information and the ninth S&F time information as example, the ninth S&F time information may indicate a first accumulated time (e.g., 10 hours) for the delivery of the downlink data packet from the third core network node to the RAN. If the RAN stores the downlink data packet for 1 hour, a second accumulated time may be a sum (e.g., 11 hours) of the first accumulated time (e.g., 10 hours) plus the time (1 hours) spent in the RAN. For example, the tenth S&F time information may comprise the second accumulated time. In other example, remaining time information of each S&F time information may be reduced by an amount of time spent in each network node.

The example depicted in FIG. 21 may assist each network node to determine how much time the each network node is allowed to store a data packet before delivering to a next network node, to determine how much time (e.g., delay budget) remains for the data packet before expiry of the delivery of the data packet, and/or the like. This may assist each network node to determine how to manage its buffer, which data packet to store, which data packet to discard at shortage of buffer. This may assist application to understand total delivery delay in a network.

In the example of FIG. 21, each S&F time information may further comprise a first location information where the UE sends the uplink data packet (e.g., where the RAN receives the uplink data packet, a cell, geographic coordinates, a TA, identifier of the RAN, country, a satellite identifier), a second location information (e.g., where the RAN sends the downlink data packet, a cell, a geographic coordinates, a TA, identifier of the RAN, country, a satellite identifier)where the downlink data packet is delivered to the UE. This information may assist for a network to accurately determine charging information.

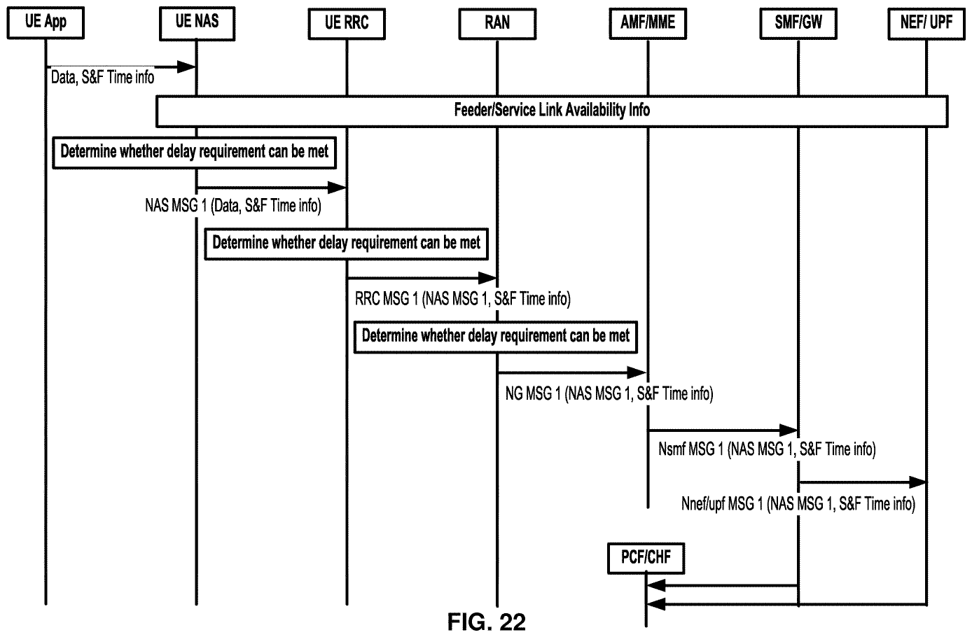

FIG. 22 depicts one example embodiment of the present disclosure. In an example, when one or more entities of a UE, one or more network nodes may share a S&F link availability information (or S&F link information). This may assist the one or more entities or the one or more network nodes to determine whether a data packet can be delivered, satisfying QoS requirement (e.g., time delay requirement, packet delay budget). For brevity, based on the other part of the present disclosure, redundant details will be omitted.

In an example, the S&F link availability information may comprise at least one of a feeder link availability information and/or a service link (e.g., access link) availability information. For example, the feeder link availability information may indicate when/where the feeder link is available, e.g., when/where a signalling (and/or data) exchange between a RAN (e.g., eNB, gNB, satellite) and a core network (e.g., AMF, MME) is possible. For example, the service link availability information may indicate when/where a service link is available, e.g., when the UE and the RAN can exchange signalling and/or data, when/where a coverage of a cell is provided to the UE.

In an example, a NAS entity of the UE, a RRC entity of the UE, the RAN, one or more core network nodes may acquire the S&F link availability information.

In an example, the NAS entity of the UE may receive the uplink data packet (as shown in the example of FIG. 21). Based on the first S&F time information and/or the S&F link availability information, the NAS entity may determine whether the uplink data packet can be delivered, satisfying QoS requirement of the uplink data packet (e.g., before expiry, within packet delay budget, within time delay tolerable to the application of the uplink data packet). For example, the first S&F time information (or QoS requirement for the uplink data packet, QoS requirement for the application, QoS requirement for a QoS flow, and/or the like) may indicate that the uplink data packet needs to be delivered in 3 hours. For example, the S&F link availability information may indicate that the feeder link (and/or also considering the service link) is available in 4 hours. In this case, the NAS entity may determine that the uplink data packet may not be delivered in a bound of time delay requirement and/or may determine not to send the uplink data packet and/or may discard the uplink data packet. In other example, the S&F link availability information may indicate that the feeder link is available in 2 hours. In this case, the NAS entity may determine that the uplink data packet can be delivered, meeting the time delay (e.g., packet budget) requirement, and/or before expiry of the uplink data packet. The NAS entity may compose the NAS MSG 1, may deliver to the RRC entity, the NAS MSG 1 and/or the second S&F time information. Similar behavior (e.g., using the SF link availability information, using the S&F time information, determining to send/discard), as described above, may be performed by e.g., the RRC entity, the RAN, the first core network node, the second core network node, the third core network node, for the uplink data packet and/or for a downlink data packet. For example, based on a S&F time information, and/or the S&F link availability information, the RAN may determine whether to forward the uplink data packet to the first core network, whether to discard the uplink data packet, and/or the like. For example, based on S&F time information, and/or the S&F link availability information, the first core network node (or the second core network node) may determine whether to forward the downlink data packet to the RAN (or the first core network), whether to discard the downlink data packet, and/or the like. For example, based on S&F time information, and/or the S&F link availability information, if the downlink data packet can be delivered before expiry (valid) time of the downlink data packet, the RAN (or the core network node) may store and/or forward the downlink data packet. For example, based on S&F time information, and/or the S&F link availability information, if the downlink data packet cannot be delivered before expiry (valid) time of the downlink data packet, the RAN (or the core network node) may not store, may discard, and/or may not forward the downlink data packet, may notify delivery failure of the downlink data packet. This may assist better usage of network resources and/or the application (and/or application server) be aware when to perform retransmission.

In an example, when the S&F mode is used, the charging information may not be correct. For example, an operator may want to apply different rate for data delivery depending on e.g., location of data delivery, time of data delivery, how long it takes to deliver the data, etc. For example, the operator may want to apply rate X when a first data is delivered non-S&F mode, and apply rate Y when a second data is delivered by S&F mode. However, unlike data delivery via a RAN in normal mode, a data delivery via the SF mode may not be near real-time and may cause inaccurate estimation at a core network. There is a need to address this issue, when one or more network nodes may receive the uplink data packet and/or the downlink data packet, for the SF mode. For example, the second core network node (e.g., SMF, SGW, PGW, AMF) may receive the uplink data packet and/or the second core network node may receive the S&F time information (e.g., one of S&F time information described above) associated with the uplink data packet. For example, the S&F time information may additionally comprise the location information (e.g., where (e.g., cell ID, TA ID, PLMN ID, NPN ID, country, geo-coordinates), the uplink data packet is transmitted/received/stored) of the uplink data packet. In response to receiving the uplink data packet and/or the S&F time information, the second core network node (or the first core network node, the third core network node) may notify a fourth core network node (e.g., PCF, CHF, charging entity and/or the like). For example, the second core network node may send to the fourth core network node, an information (e.g., size, amount, number, target application, and/or the like) of the uplink data packet, whether the SF mode is used, whether the data is for IoT, and/or the S&F time information. For example, the information may be a charging record information. This may assist the fourth core network node to accurately estimate/generate/calculate a charging/billing information. In an example, the network may send the charging information to the application server, associated with the uplink data packet. Similar operation may be applicable for a downlink data packet. For example, when the downlink data packet is delivered to the UE via a RAN and if the SF mode is used, the RAN (or the first core network node, the second core network node, the third core network node) may send a delivery information to the fourth core network. The delivery information may indicate whether the downlink data packet is delivered to the UE or not, when the downlink data packet is delivered, where the downlink data packet is delivered, the amount of time spent for the delivery, whether SF mode is used, and/or the like. This may help the core network to generate accurate charging information.

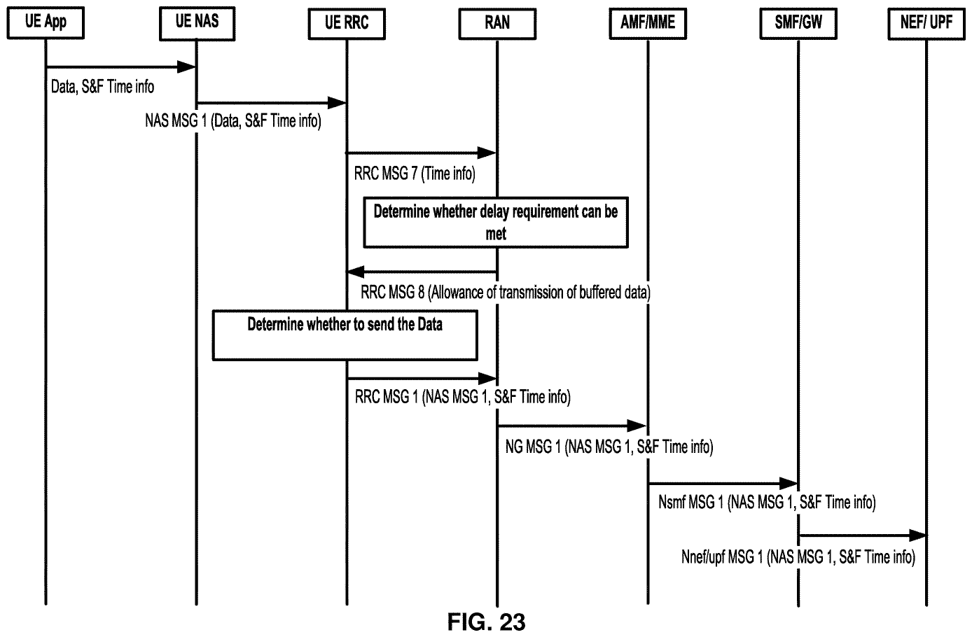

FIG. 23 depicts one example embodiment of the present disclosure. In an example, a UE may send information of one or more uplink data packets to a RAN. This may help the RAN to determine whether the uplink data packet can be delivered, satisfying QoS requirement (e.g., time delay requirement, packet delay budget). This may assist efficient use of radio resource. For brevity, based on the other part of the present disclosure, redundant details will be omitted.

In an example, the RRC entity of the UE may receive the NAS MSG 1 and/or with the second S&F time information. In other example, the NAS entity of the UE may request the RRC entity to establish an RRC connection with the RAN, and/or may query whether uplink data transmission is possible or not. In response, the RRC entity may send a RRC MSG 7 to the RAN. For example, the RRC MSG 7 may comprise at least one of:
an indication indicating that the UE supports the S&F mode.
an indication indicating that the UE has one or more uplink data packets to send.
one or more S&F time information of the one or more uplink data packets.

For example, the RRC MSG 7 may assist the RAN to determine whether the one or more uplink data packets can be delivered, meeting QoS requirements. For example, based on the RRC MSG 7 and/or the S&F link availability information, the RAN may determine. For example, the RRC MSG 7 may indicate that the uplink data packet expires in 2 hours. For example, if the feeder link is available in 3 hours, the RAN may determine that the QoS may not be met for the uplink data packet. In other example, if the feeder link is available in 1 hours, the RAN may determine that the QoS requirement may be met for the uplink data packet. In response to determining that the QoS requirement can be met for the uplink data packet, the RAN may send a RRC MSG 8 to the UE.

In an example, the RRC MSG 8 may indicate that transmission of the uplink data packet is allowed, and/or that QoS requirement (e.g., time requirement) for the uplink data packet can be met.

In an example, the UE may receive the RRC MSG 8. Because the RRC MSG 8 indicates that QoS requirement can be met for the uplink data packet, the UE may determine to send the uplink data packet. For example, the UE may send the RRC MSG 1.

The example of FIG. 23 may reduce unnecessary transmission of the UE.

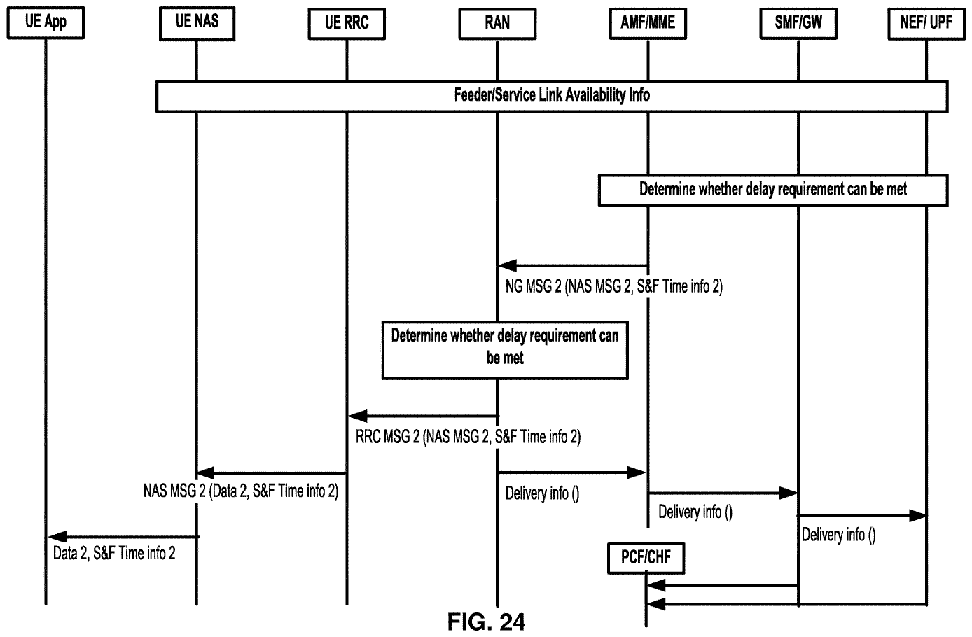

FIG. 24 depicts one example embodiment of the present disclosure. In an example, a core network node may determine whether a downlink data packet can be delivered, satisfying QoS requirement (e.g., time delay requirement, packet delay budget). This may assist efficient use of network resource. For brevity, based on the other part of the present disclosure, redundant details will be omitted.

In an example, a third network node may receive the downlink data packet and/or a 21^{st} S&F time information. An application server sending the downlink data packet may also deliver the 21^{st} S&F time information to the third network node. For example, the 21^{st} S&F time information may indicate whether the S&F mode is allowed for the downlink data packet, one or more time value (e.g., one or more time value, expiration time, validity time, valid location, packet delay budget, maximum storing time, one or more similar values of the S&F time information describe above, and/or the like) of QoS requirement. In an example, based on the 21^{st} S&F time information and/or based on the S&F link availability information, the third network node may determine whether the downlink data packet can be delivered, meeting QoS requirement (e.g., delivering within expiry time, or within packet delay budget), when the S&F mode is used. In an example, if the 21^{st} S&F time information indicates that the S&F mode is allowed for the downlink data packet, if the downlink data packet can be delivered within time delay budget, and/or if the S&F mode is currently used for the UE, the third core network node may send to the second core network node, the downlink data packet, indication of allowance of SF mode, and/or the seventh S&F time information. For example, the Nnef MSG 2 may be used.

In an example, the second core network node may receive the Nnef MSG 2 from the third core network node. For example, based on the Nnef MSG 2 and/or based on the S&F link availability information, the second core network node may determine whether the downlink data packet can be delivered to the UE, meeting QoS requirement. For example, the similar behavior described above for the third core network node may be performed by the second core network node. For example, the seventh S&F time information may indicate that the downlink data packet needs to be delivered in 4 hours. For example, the S&F link availability information may indicate that the feeder link is available in 2 hours and/or that the service link is available in 3 hours. Because the downlink data can be delivered to the UE in 3 hours, because the downlink data packet is valid for 4 hours, and/or because the data packet is allowed to use the S&F mode, the second core network may determine to store the downlink data packet, may forward the downlink data packet when the feeder link is available, and/or may send the Nsmf MSG 2 to the first core network node when the feeder link is available. In other example, the S&F link availability information may indicate that the feeder link is available in 5 hours and/or that the service link is available in 3 hours. Because the downlink data cannot be delivered to the UE in 4 hours, because the downlink data packet is valid for 4 hours, and/or if the data packet is not allowed to use the S&F mode, the second core network may determine not to store the downlink data packet, may discard the downlink data packet, and/or may send to the third core network node, a notification that the downlink data is discarded. Similar behavior described above may also be performed by the first core network node, and/or the RAN, with S&F time information available to the node. For example, in case of RAN, it may consider also the service link availability information.

In an example, as briefly mentioned above, when a node discards a data packet and/or when the node determine that the data packet cannot be delivered with a certain time limit (e.g., QoS requirement, packet delay budget), the node may send a delivery report. For example, for the downlink data packet, the second core network node may send the delivery report to the third core network node. Respectively, the RAN may send the delivery report of the downlink data packet to the first core network node. This delivery report may indicate at least one of whether the downlink data packet can be delivered within a time threshold (e.g., expiry time, maximum packet delay budget, and/or the like) when the SF mode is activated (used), whether the downlink data packet is discarded or not, where the downlink data packet is delivered to the UE, and/or the like. This may help one or more core network nodes to send a charging information (e.g., charging data records (CDRs)) to the fourth core network node (e.g., PCF, charging function (CHF), charging data function (CDF), charging gateway function (CGF), charging trigger function (CTF), online charging function (OCF), offline charging function (OFCF) and/or the like).

The example of FIG. 24 may help in increasing resource usage efficiency, may assist early awareness of data transfer status.

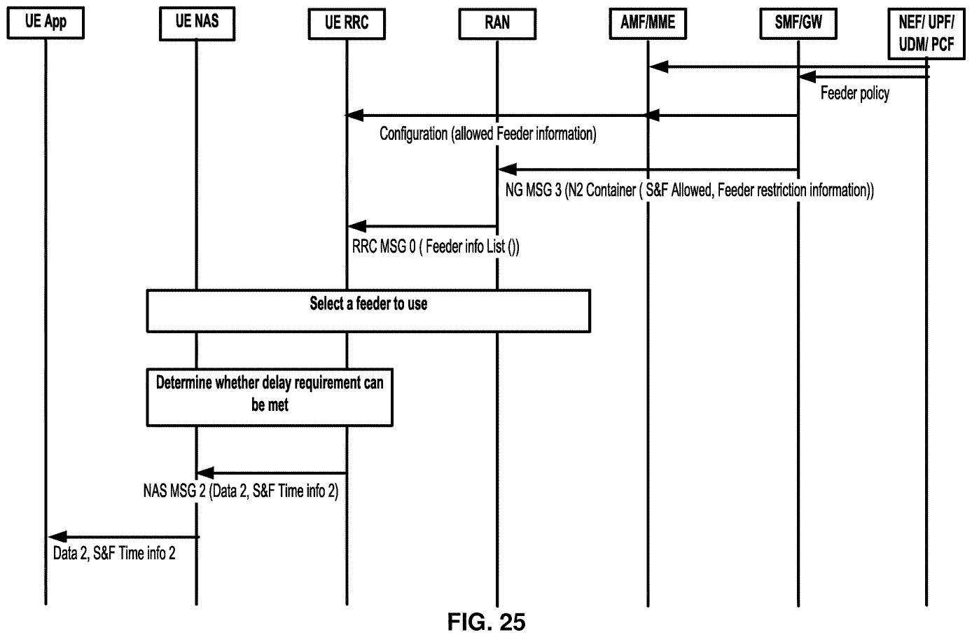

FIG. 25 depicts one example embodiment of the present disclosure. In an example, a network node may use a feeder policy information. This may assist for the network node to determine more accurately time related issue, and/or to evaluate whether QoS requirement (e.g., time delay requirement, packet delay budget) can be met. For brevity, based on the other part of the present disclosure, redundant details will be omitted.

In an example, a satellite (e.g., a NTN-RAN) may have one or more feeder links. For example, the satellite may fly over Asia at time Tx, over Europe at time Ty, and/or over North America at time Tz. For example, when the satellite flies over Indian ocean, Pacific ocean, and/or Atlantic ocean, there may be no available feeder link. For example, when the satellite flies over Asia, the satellite may use a first feeder link via Korea. For example, when the satellite flies over Europe, the satellite may use a second feeder link via France. For example, when the satellite flies over North America, the satellite may use a third feeder link via USA. In this case, depending on which feeder link is used, actual time until a data packet can be delivered may vary. As described below, more accurate estimation may be required.

In an example, one or more network nodes may be configured with the S&F link availability information. The feeder link availability information of the S&F link availability information may comprise one or more feeder link information. A feeder link information of the one or more feeder link information may comprise at least one of an identifier of the feeder link, one or more time period information of the feeder link, one or more location information of the feeder link, one or more country information of the feeder link, one or more network information of the feeder link, and/or the like. For example, the one or more period information may indicate when the feeder link is available. For example, the one or more location information may indicate where the feeder link is available, and this may be related to the one or more time period information. For example, the one or more country information may indicate which countries are served (or allowed) for the feeder link. For example, the one or more network information may indicate which networks are served (or allowed) for the feeder link.

In an example, the third core network node (or the second core network node, the first core network node, the RAN, the UE) may receive the S&F link availability information. For example, the S&F link availability information may comprise a first feeder link information and/or a second feeder link information. For example, the first feeder link information may indicate a first time period information, a first location information, a first country information, a first network information. For example, the second feeder link information may indicate a second time period information, a second location information, a second country information, a second network information. For example, the S&F link availability information may comprise information of similar characteristic for one or more service links.

In an example, one or more network node may receive a feeder link policy information. For example, a fifth core network node (e.g., UDM, HSS, PCF, PCRF, PCEF, NEF, SCEF, and/or the like) may receive and/or send the feeder link policy information to the second core network node (or, the first core network node, the second core network node, the RAN, the UE). For example, the first core network node (or the second core network node) may send the feeder link policy information to the RAN (or the UE). For example, the feeder policy information may indicate at least one of, whether the UE is allowed to use a feeder link, whether the UE is allowed to use the S&F mode, which feeder link the UE is allowed to use, in which country the UE is allowed to use a feeder link, in which country the UE is allowed to use the S&F mode, which network the UE is allowed to use via the feeder link, which network the UE is allowed to use via the S&F mode, and/or the like. For example, the feeder policy information may comprise similar information for the service link. For example, the UE may use the feeder policy information, when the UE determine whether to send one or more uplink data packet in SF mode.

In an example, the second core network node (e.g., SMF, S-GW, P-GW, or the first core network node) may determine to establish a PDU session (or a PDN connection) for the UE. For example, the second core network (or the first core network node) may send to the RAN, a N2 container. For example, the N2 container may indicate at least one of whether the S&F mode is allowed for the UE (or for the PDU session, for the PDN connection), whether the S&F mode is allowed for the PDU session, and/or a feeder link restriction information. For example, the feeder link restriction information may be the feeder policy information and/or may comprise similar information. For example, the RAN may use the feeder link restriction information for the UE (or for the PDU session), when a data packet is received/delivered. For example, the RAN may send (forward) the uplink data packet to the first core network via the feeder link, if the feeder link is allowed for the UE (or for the PDU session), and/or if a network (of the first core network node) is allowed for the UE (or for the PDU session, or for the S&F mode).

In an example, the UE may receive the RRC MSG 0. For example, the RRC MSG 0 may comprise the S&F link availability information. For example, the S&F link availability information may comprise the feeder link information.

In an example, the UE may determine to send the RRC MSG 1. For example, the UE may select a feeder link among one or more feeder links indicated by the feeder link information. For example, the UE may select the feeder link, based on the feeder link policy information. For example, based on current location of the UE, based on time when each feeder link is available, based on the S&F time information, the UE may select the feeder link. For example, if a feeder link 1 is for country X, and if the UE is in country X or if the uplink data packet is to be sent to country X, then the UE may select the feeder link 1. For example, based on the S&F time information, the UE may determine the feeder link which can meet QoS requirement. In other example, the UE may first select the feeder link, and may determine whether QoS requirement can be met for the uplink data packet. In an example, if there is the feeder link that can meet QoS requirement of the uplink data packet, the UE may send the RRC MSG 1 via the selected feeder link. Or, the UE may send the RRC MSG 1 comprising an indication indicating the selected feeder link. This may help the RAN to decide which feeder link to use, when the RAN forwards the uplink data to a core network.

In other example, the UE may receive the RRC MSG 0. In response to receiving the RRC MSG 0, the UE (e.g., the RRC entity, the NAS entity) may deliver to the application, the information of the feeder link. For example, the NAS entity may indicate to the application, when the feeder link is available, which application can use the feeder link, where the feeder link is available. This may help the application to control the timing when the uplink data packet is generated, may help the NAS entity (or the RRC entity) to decide whether there is an available feeder link, when the feeder link is available, which feeder link to select.

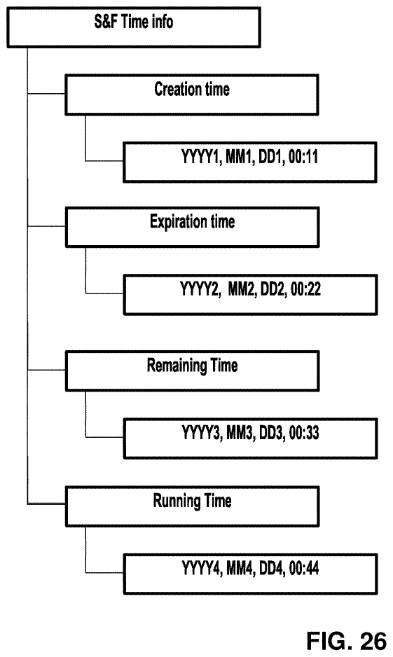

FIG. 26 depicts one example embodiment of the present disclosure. In an example, the S&F time information (e.g., the first S&F time information, the second S&F time information, and so on) may comprise one or more field.

In an example, the S&F time information may comprise at least one of a creation (or generation, transmission, sending) time for a data packet. For example, this may indicate when the data packet is generated, when the data packet is received, when the data packet is transmitted, and/or the like. For example, for different nodes, a value of this may be different, for the data packet. For example, for the same packet, a first received time at the RAN may be different from a second received time at the UE.

In an example, the S&F time information may comprise at least one of an expiration (valid, threshold) time of a data packet. For example, this may indicate when the data packet expires, when the data packet is no longer needed, when (e.g., absolute time, e.g., AM 10:00) the data packet is to be discarded (expire), and/or the like.

In an example, the S&F time information may comprise at least one of a remaining time of a data packet. For example, this may indicate after what time (e.g., relative time, e.g., 1 hours later, in 10 minutes) the data packet expires, how long the data packet can be kept/stored/handled in a network, a remaining time delay budget, and/or the like. For example, for different nodes, the value may be different. For example, for the same packet, a first remaining time at the RAN may be different from a second remaining time at the first core network node, e.g., based on how much time buffering consumed at each node.

In an example, the S&F time information may comprise at least one of a running (e.g., elapsed, spent) time of a data packet. For example, this may indicate after creation of the data packet how much time passes, or how much time the data packet stays at each node (a network), and/or the like. For example, for different nodes, the value may be different. In other example, a plurality of running time value may be included in the S&F time information.

In an example, the S&F time information may be updated at each node, as the data packet is forwarded via the each node.

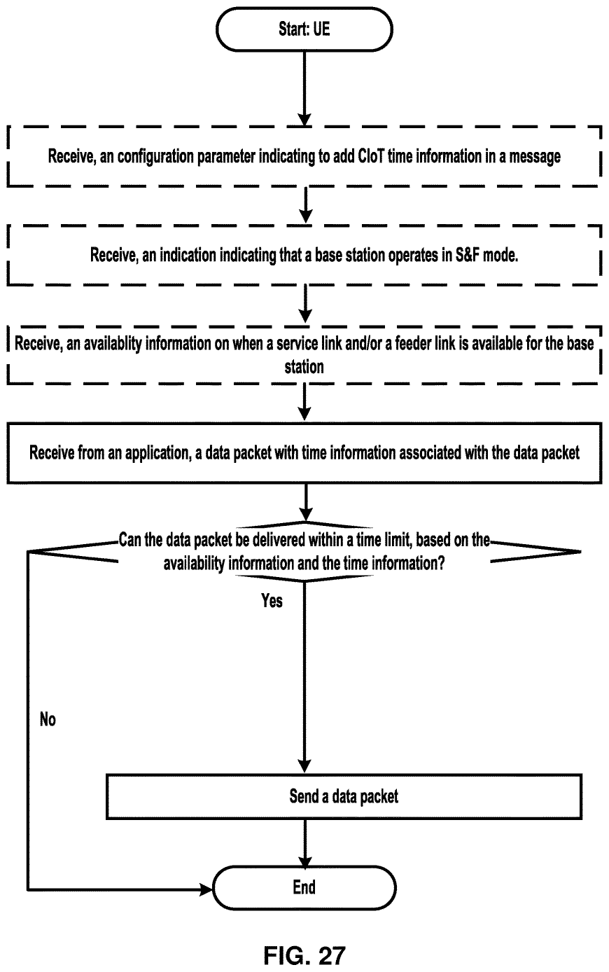

FIG. 27 depicts one example embodiment of the present disclosure. In an example, the UE may receive a configuration parameter indicating to add a S&F time information (e.g., a CIoT, IoT, time information) in a message (e.g., a user plane access stratum PDU, a CIoT NAS message, a RRC message for CIoT data delivery). In an example, the UE may receive an indication indicating that a base station (or a network) operates (or uses, activates) a S&F mode. In an example, the UE may receive, an availability information on when a service link (e.g., access link) is available and/or on when a feeder link (e.g., backhaul link) is available. In an example, because the base station is in the S&F mode, and/or because of the configuration parameter, the UE may receive from an application, a data packet with a S&F time information associated with the data packet. The UE may determine, based on the S&F time information and/or the availability information, whether the data packet can be delivered in a time limit (e.g., within a packet delay budget, within expiration time). If the UE determines that the data packet can be delivered in the time limit, the UE may send the data packet. Otherwise, the UE may not send the data packet.

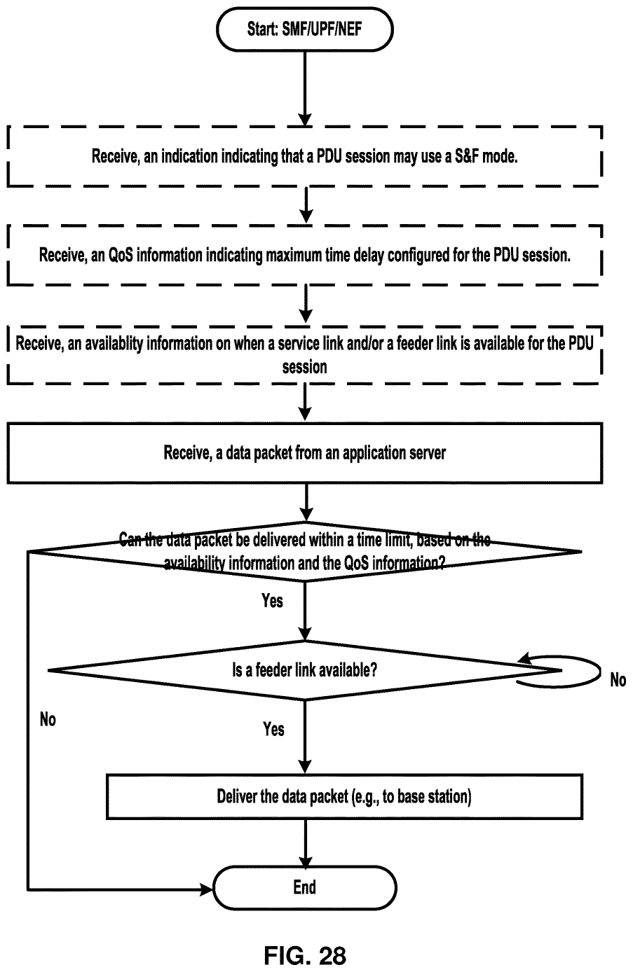

FIG. 28 depicts one example embodiment of the present disclosure. In an example, a second core network (e.g., SMF, UPF, P-GW, SCEF, S-GW, AMF, MME, NEF, and/or the like) may receive an indication that a PDU session (or a UE) uses an S&F mode. In an example, the second core network may receive a QoS information indicating a maximum time delay (e.g., packet delay budget) for the PDU session (or the UE, or for each data packet). In an example, the second core network node may receive an S&F link availability information on when a service link and/or a feeder link is available for the PDU session (or for the UE or for the base station), and/or information of a radio access network (of the S&F mode) serving the PDU session (or the UE). In an example, the second core network node may receive a downlink data packet. For example, the second core network node may determine, based on the S&F link availability information, whether the downlink data packet can be delivered within a time limitation (e.g., packet delay budget for the downlink data packet). In an example, based on the determination, the second core network node may store the downlink data packet until the feeder link is available (or until the second core network node receives a notification of availability of the feeder link). In an example, if the feeder link is available, the second core network node may send the downlink data packet to the RAN. For example, if the expiration time (e.g., valid time) has not yet passed for the downlink data packet, the second core network node may forward the data to the first core network node and/or the RAN.

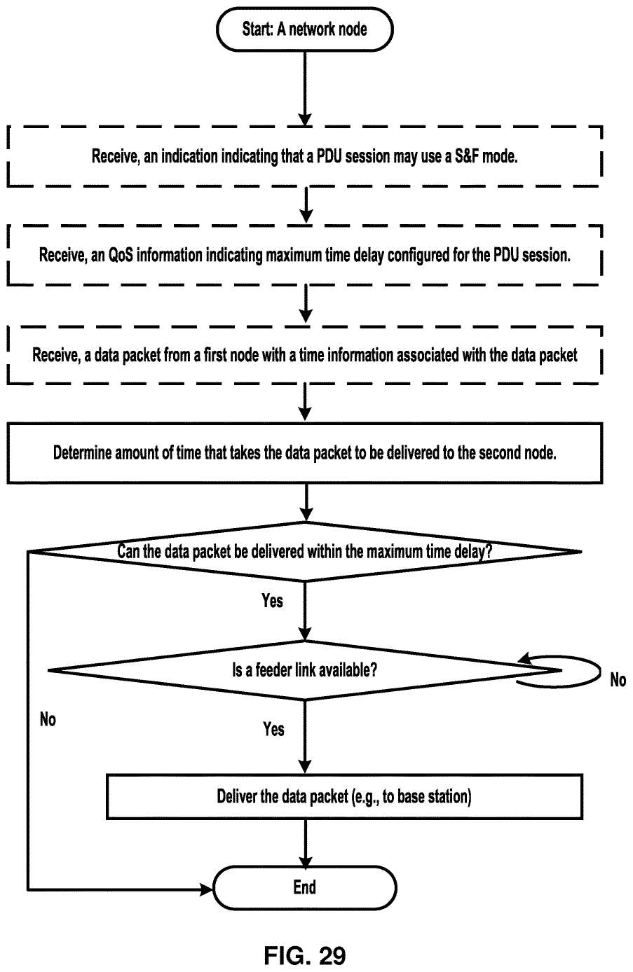

FIG. 29 depicts one example embodiment of the present disclosure. In an example, a RAN (base station, eNB, gNB, and/or the like) may receive an indication that a PDU session (or a UE) uses an S&F mode. In an example, the RAN may receive a QoS information indicating a maximum time delay (e.g., packet delay budget) for the PDU session (or the UE, or for each data packet). For example, the RAN may receive the QoS information for control plane data delivery. For example, with the control plane data delivery, a user data (e.g., a data packet of an application) may be delivered by a NAS entity (e.g., entity handling mobility management, e.g., entity handling session management) and/or by a RRC entity (e.g., RRC layer). For example, with user plane data delivery, a user data may be delivered not by a NAS entity (e.g., entity handling mobility management, e.g., entity handling session management) and/or not by a RRC entity (e.g., RRC layer). For example, for control plane delivery, the data packet may be delivered from application layer to NAS layer to RRC layer to PDCP layer. For example, for user plane delivery, the data packet may be delivered from application layer to PDCP layer. In an example, the RAN may receive an S&F link availability information on when a service link and/or a feeder link is available for the PDU session (or for the UE), and/or information of a radio access network (of the S&F mode) serving the PDU session (or the UE). In an example, the RAN may receive a data packet from a first node (e.g., a UE, or a core network node). For example, the RAN may determine, based on the S&F link availability information, whether the data packet can be delivered within a time limitation (e.g., packet delay budget for the data packet). In an example, based on the determination, the RAN may store the data packet until the feeder (respectively, a service link) is available until the second node (or the core network node, or respectively, the UE is available). In an example, if the feeder link (respectively, the service link) is available, the RAN node may send the data packet to the core network (respectively, the UE). For example, if the expiration time (e.g., valid time) has not yet passed for the data packet, the RAN node may forward the data to the second node.

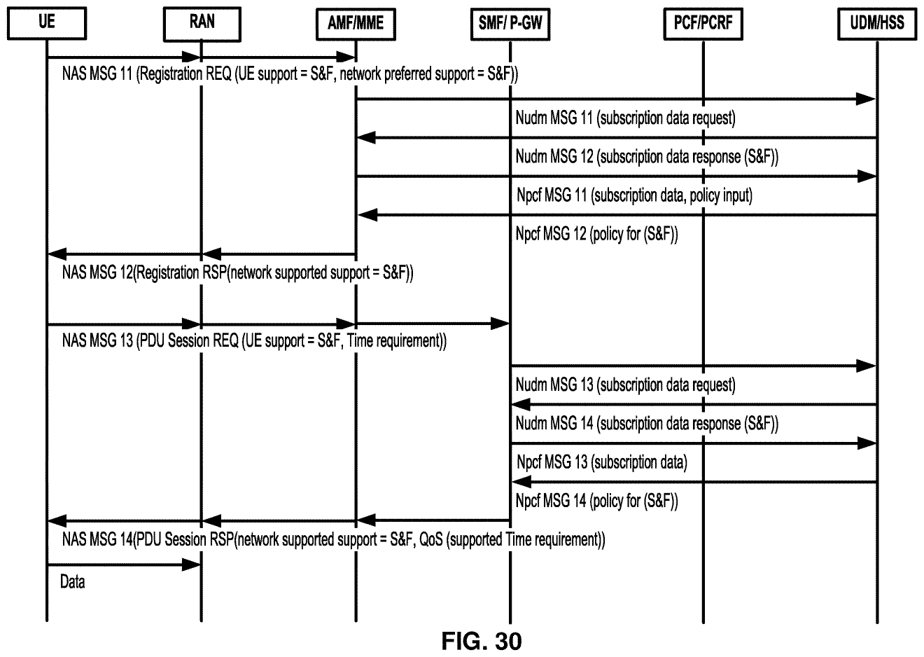

FIG. 30 depicts one example embodiment of the present disclosure. In an example, A UE may send an information on a time requirement for data delivery when a S&F mode is used. Based on the time requirement and/or based on S&F link availability information, a network may determine whether a data packet for the UE can be delivered, meeting QoS requirement. For brevity, based on the other part of the present disclosure, redundant details will be omitted.

In an example, the UE may perform registration to a network. For example, the UE may send a NAS MSG 11, to a first network node (e.g., AMF, MME). The NAS MSG 11 may be at least one of a registration request message, a attach request message, a tracking update request message, a service request message, and/or the like. For example, the NAS MSG 11 may comprise at least one of:
a capability indicator indicating the UE supports the S&F mode. For example, this may indicate that the UE can process one or more information for the S&F mode, and/or can connect to a RAN (or a network, a core network) of the S&F mode, can do action for the S&F mode, and/or the like. This may help a network to determine whether to use a functionality associated with the S&F mode to the UE, and/or whether to use a network supporting the S&F mode.
a preferred network behavior indicating the UE requests a network supporting the S&F mode. For example, this may indicate that the UE wants to network to support the functionality associated with the S&F mode. If this is not indicated, it may mean that the UE does not request a network to support the S&F mode. This may help for a network whether to select one or more network supporting the S&F mode.

In an example, in response to receiving the NAS MSG 11, the first network node may send a Nudm MSG 11 (e.g., HSS MSG 11) to a third network node (e.g., UDM, UDR, HSS). For example, the Nudm MSG 11 may request a subscription information of the UE.

In an example, in response to the Nudm MSG 11, the first network node may receive a Nudm MSG 12. For example, the Nudm MSG 12 may comprise a subscription information of the UE. For example, the subscription information may indicate at least one of whether the UE is allowed to use the S&F mode, when the UE is allowed to use the S&F mode, and/or where the UE is allowed to use the S&F mode. Based on the subscription information, the first network node may determine whether to allow the S&F mode for the UE or not.

In an example, in response to receiving the NAS MSG 11, the first network node may send a Npcf MSG 11 (e.g., PCRF MSG 11) to a fourth network node (e.g., PCF, PCRF). For example, the Npcf MSG 11 may request a policy information of the UE. In other example, a second network node (e.g., SMF, P-GW, S-GW) may request the policy information.

In an example, in response to the Npcf MSG 11, the first network node may receive a Npcf MSG 12. For example, the Npcf MSG 12 may comprise a policy information of the UE. For example, the policy information may indicate at least one of whether the UE is allowed to use the S&F mode, when the UE is allowed to use the S&F mode, and/or where the UE is allowed to use the S&F mode, a time requirement when the S&F mode is used. Based on the policy information, the first network node may determine whether to allow the S&F mode for the UE or not.

In an example, in response to the NAS MSG 11, the first network node may send to the UE, a NAS MSG 12. The NAS MSG 12 may indicate whether the UE is registered, whether the UE is allowed to use the S&F mode, and/or a supported network Behaviour. For example, the supported network Behaviour may indicate whether the network (of the first network node) and/or the first network node supports the S&F mode. This may assist the UE to determine whether to perform a step associated with the S&F mode.

In an example, the UE may receive the NAS MSG 12. In an example, if the UE receives the supported network behavior indicating the SF mode, and/or if the RAN indicates activation of the S&F mode, the UE may determine to use the S&F mode.

In an example, the UE may send a NAS MSG 13. For example, the NAS MSG 13 may request a PDU session (or PDN connectivity). For example, the NAS MSG 13 may indicate at least one of whether the UE supports the PDU session with the S&F mode, whether the UE requests the PDU session with the S&F mode, and/or a time requirement (e.g., uplink packet delay budget, downlink packet delay budget) for the S&F mode. For example, the time requirement for the S&F mode may indicate a maximum uplink time requirement (e.g., packet delay budget). For example, the time requirement may be for an uplink data packet, for an application, and/or for a PDU session. For example, the UE may send the time requirement information, based on that the UE is under a RAN (a network, a core network) using the S&F mode and/or based on that the UE is allowed for the SF mode. For example, the time requirement may indicate the maximum time duration (or delay, budget) that the application may support (e.g., sustain). For example, if the application request that the data needs to be delivered in 2 hours, the maximum uplink time requirement may indicate 2 hours.

In an example, the first network node may receive the NAS MSG 13. The first network node may send to a second network node (e.g., SMF, P-GW, S-GW) at least one of the NAS MSG 13, one or more information element of the NAS MSG 13, and/or a radio access network information. For example, the radio access network information may indicate whether the RAN uses the S&F mode or not, the maximum delay of the feeder link, the maximum delay of the service link, whether the S&F mode is allowed, and/or the like.

In an example, the second network node may receive at least one of the NAS MSG 13, one or more information element of the NAS MSG 13, and/or a radio access network information. In response, the second network node may receive the subscription information from the third network node, the policy information from the fourth network node, and/or the like

In an example, based on the policy information, the subscription information, the time requirement and/or the S&F link availability information, the second network node may determine whether the time requirement can be met. For example, based on the policy information, the subscription information, the time requirement and/or the S&F link availability information, the second network node may determine achievable QoS (e.g., maximum supported (achievable, sustainable, providable, implementable) packet delay using the S&F mode). In the determination, the second network node may use the information of the RAN where the UE is connected, the location of the UE, the time when the feeder link is available, the maximum time during which the feeder link is not available, and/or the like. Based on the determination, the second network node send to the UE, a response message. For example, the response message may indicate whether the PDU session (e.g., the PDN connection) supports the S&F mode, whether the UE is allowed for the S&F mode for the PDU session, whether the network supports the S&F mode, QoS information of the PDU session, and/or the like. For example, the QoS information of the PDU session may indicate a supported QoS for the PDU session. For example, the supported QoS for the PDU session may indicate a supported time requirement (e.g., the achievable QoS, e.g., the maximum supported time (packet) delay when the S&F mode is used). In other example, the supported QoS may indicate the maximum delay that the UE is allowed to send.

In an example, the UE may receive the response message. Based on the response message, the UE may determine the maximum supported time delay for a data packet when the S&F mode is used. Based on the maximum supported time delay, the UE may be able to determine which data packet can be sent or to be discarded. For example, if the maximum supported time delay is 2 hours, and if the data packet needs to be delivered in 1 hours, the UE may not send the data packet and/or may discard the packet. For example, if the maximum supported time delay is 2 hours, and if the data packet needs to be delivered in 3 hours, the UE may send the data packet for S&F mode.

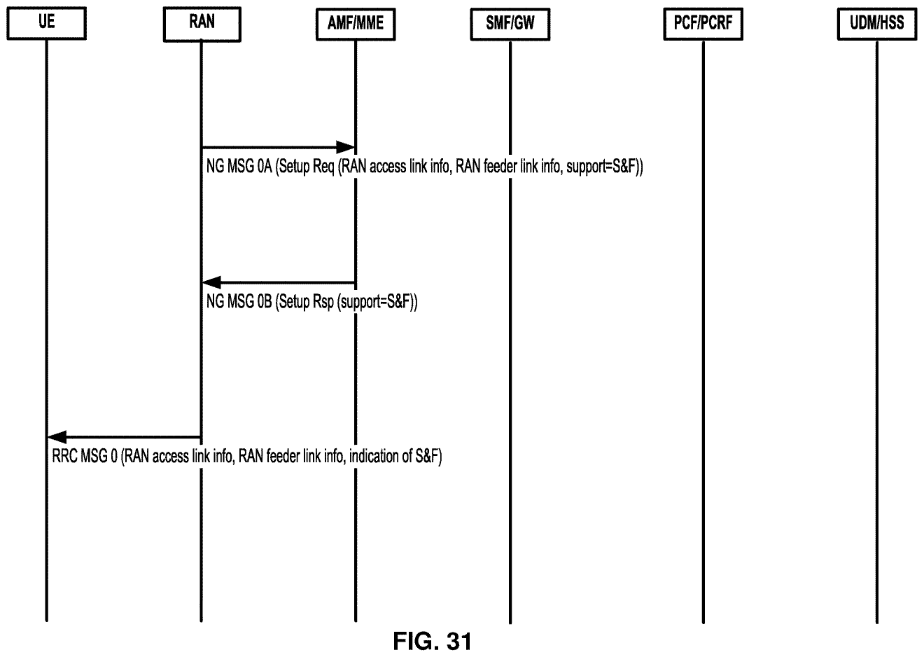

FIG. 31 depicts one example embodiment of the present disclosure. In an example, one or more network nodes may need the S&F link availability information. For example, during a NG setup, a RAN can inform a core network the S&F link availability information. This may assist the behavior described earlier. For brevity, based on the other part of the present disclosure, redundant details will be omitted.

In an example, after powering up and/or receiving updated configuration information, a RAN (e.g., eNB, gNB) may send a first NG message (e.g., S1) message to a core network node (e.g., MME, AMF). For example, the first NG message may be at least one of NG setup, S1 setup, NG configuration update, S1 configuration update, and/or the like. For example, the NG message may comprise the S&F link availability information, an indication indicating that the RAN supports the S&F mode, an indication indicating that the RAN operates in the S&F mode, and/or the like.

In an example, in response to sending the NG message, the first NG message (e.g., S1) message, the RAN may receive a second NG message. For example, the first NG message may be at least one of NG setup response, S1 setup response, NG configuration update response, S1 configuration update response, and/or the like. For example, the second NG message may comprise the S&F link availability information, an indication indicating that the core network node supports the S&F mode, an indication indicating that the core network node operates in the S&F mode, and/or the like.

In an example, the RAN may send the RRC MSG 0. For example, the RAN may send the RRC MSG 0, based on the information indicated by the first NG message and/or the second NG message.

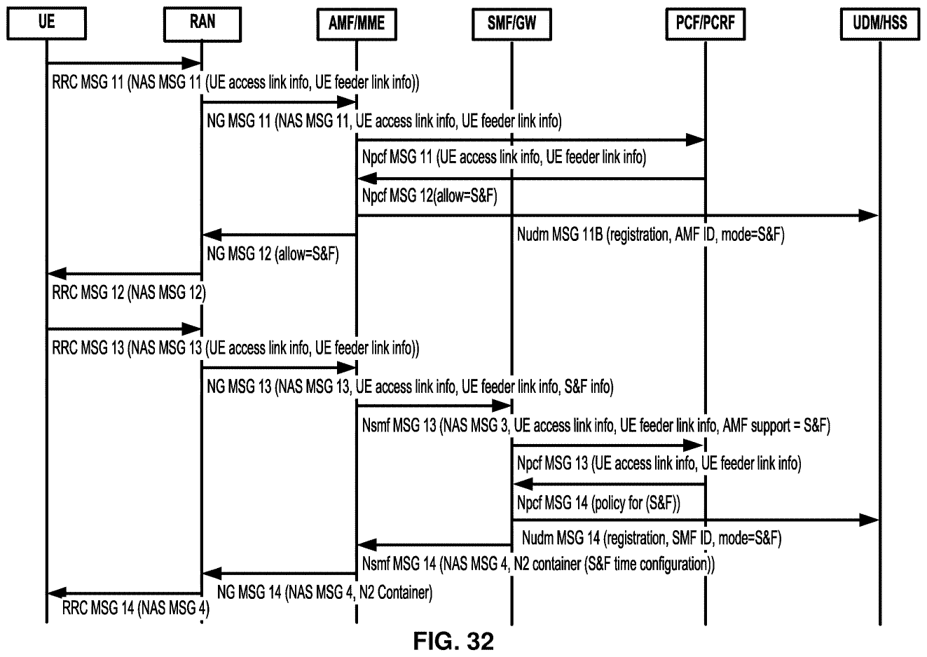

FIG. 32 depicts one example embodiment of the present disclosure. In an example, one or more network nodes may acquire the S&F link availability information, and may use the S&F link availability information to determine QoS configuration and/or QoS requirement. For brevity, based on the other part of the present disclosure, redundant details will be omitted.

In an example, the UE may perform the registration to the network. For example, the UE may send the NAS MSG 11, to the first network node (e.g., AMF, MME). The NAS MSG 11 may be at least one of a registration request message, an attach request message, a tracking update request message, a service request message, a control plane service request message, and/or the like. For example, the NAS MSG 11 may further comprise a first S&F link information. For example, the first S&F link information may indicate at least one of a service link information and/or a feeder link information. For example, the service link information may indicate a first service link used (selected) by the UE, and/or when the first service link is available. For example, the first feeder link information may indicate a first feeder link used (selected) and/or when the feeder link is available. For example, the UE may acquire the first service link information and/or the first feeder link information, based on the RRC MSG 0. In other example, if the RRC MSG 0 indicates one or more feeder links, the first feeder link information may indicate a feeder link selected among the one or more feeder links. Alternatively and additionally, an RRC MSG 11 comprising the NAS MSG 11 may further comprise the first S&F link information. For example, the RAN may receive the RRC MSG 11 and may send a NG MSG 11 (or S1 MSG 11) to the first network node. For example, the NG MSG 11 may comprise the NAS MSG 11 and/or a second S&F link information. The first network node may receive the NAS MSG 11 via the NG MSG 11. For example, the second S&F link information may indicate a second service link and/or a second feeder link. For example, the second service link may indicate a service link from which the RAN receives the NAS MSG 11 and/or when the second service link is available. For example, the second feeder link may indicate a feeder link via which the RAN sends the NG MSG 11, and/or when the second feeder link is available.

In an example, the first network node may receive the NG MSG 11. In response to receiving the NAS MSG 11, the first network node may send the Npcf MSG 11 (e.g., PCRF MSG 11) to the fourth network node (e.g., PCF, PCRF). The Npcf MSG 11 may comprise the first S&F link information and/or the second S&F link information. This may assist the fourth network node to determine relevant policy for the SF mode.

In an example, in response to the Npcf MSG 11, the first network node may send the Npcf MSG 12. For example, the Npcf MSG 12 may comprise the policy information of the UE (for the SF mode) and/or the SF policy information. In an example, the policy information may be delivered to the UE.

In an example, in response to the NAS MSG 11, the first network node may send to the UE, the NAS MSG 12.

In an example, the first network node may send a registration message to the third network node (e.g., UDM, HSS). For example, the registration message, may indicate the registration of the first network node (e.g., MME, AMF) for handling (managing) the UE, and may indicate that the first network node operates in S&F mode, and/or that the UE is registered for S&F mode.

In an example, the UE may receive the NAS MSG 12.

In an example, the UE may send the NAS MSG 13 for a session establishment. For example, the NAS MSG 13 may further comprise the first S&F link information. Alternative, a RRC MSG 13 may comprise the NAS MSG 13 and/or the first S&F link information. The UE may send the RRC MSG 13 to the RAN.

In an example, the RAN receives the RRC MSG 13 and may send to the first network, a NG MSG 13. The NG MSG 13 may comprise the NAS MSG 13 and/or the second S&F link information. In some example, the second S&F link information may be the first S&F link information. The first network node may send to the second network node at least one of the NAS MSG 13, one or more information element of the NAS MSG 13, and/or the second (or the first) S&F link information. This may assist the second network node to determine whether to establish the PDU session and/or to determine QoS parameter relevant for the UE (or the location, the used service, the used feeder link) when the SF mode is used for the UE and/or the PDU session.

In an example, the second network node may receive at least one of the NAS MSG 13, one or more information element of the NAS MSG 13, and/or the second S&F link information. In response, the second network node may receive the subscription information from the third network node, the policy information from the fourth network node, and/or the like. For example, the second network node may send a Npcf MSG 13 to the fourth network node. The Npcf MSG 13 may comprise at least one of QoS requirement requested for the PDU session, the second S&F link information, and/or the like. This may assist the PCF to construct the policy information relevant for the SF mode.

In an example, based on the policy information (e.g., indicating one or more QoS parameter for the S&F mode, indicating whether S&F is allowed for the PDU session, indicating when/where the UE is allowed for S&F mode), the subscription information, the time requirement and/or the S&F link availability information, the second network node may determine whether the time requirement can be met for the UE (for the PDU session, for the data packet) and/or whether to establish the PDU session. For example, based on the policy information, the subscription information, the time requirement and/or the S&F link availability information, the second network node may determine achievable QoS (e.g., maximum packet delay using the S&F mode). In the determination, the second network node may use the information of the RAN where the UE is connected, the location of the UE, the time when the feeder link is available, the maximum time during which the feeder link is not available, and/or the like. Based on the determination, the second network node send to the UE, the response message. In addition, the second network node may send configuration (e.g., N2 container) to the RAN.

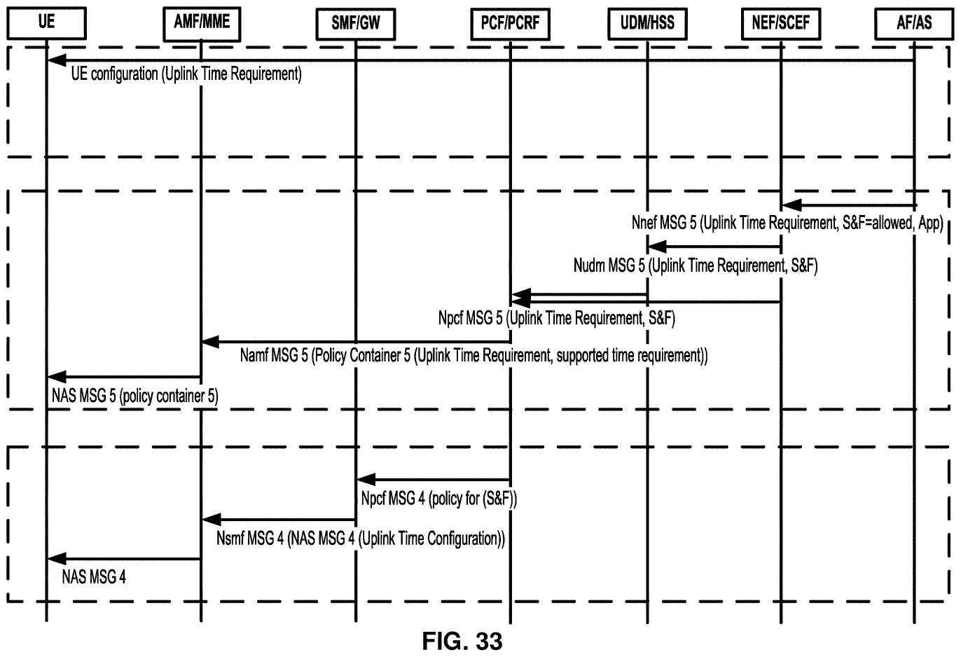

FIG. 33 depicts one example embodiment of the present disclosure. In an example, an application server of an application may provide QoS requirement. For brevity, based on the other part of the present disclosure, redundant details will be omitted.

In an example, the application server may provide to a UE, information of uplink time requirement for the application. For example, the application server of the application may know how old data the application can accept and/or handle. For example, the application server may know whether the application server can handle a data generated up to 2 hours ago or not. For example, the application server may determine that the uplink time requirement for the application is 2 hours, if the application server can handle a data generated up to 2 hours ago. For example, the application server may determine that the uplink time requirement for the application is 30 minutes, if the application server can handle a data generated less than 30 minutes ago.

In an example, based on the determination, the application server may send to the UE, the uplink time requirement of the application. For example, the uplink time requirement may indicate a maximum packet delay budget for an uplink data packet for the application. The maximum packet delay budget for the uplink data packet for the application may be similar or may be different from a maximum packet delay budget for a downlink data packet for the application, depending on characteristic. For example, if the UE is a remote telemetric device, the downlink data packet may comprise an instruction and/or the uplink data packet may comprise a measurement data. Accordingly, an allowed time delay for the uplink and for the downlink may or may not be different.

In other example, the application server may send to a fifth node (e.g., NEF, SCEF), a Nnef MSG 5. The Nnef MSG 5 may comprise at least one of the uplink time requirement of the application, an indication of whether a SF mode is allowed for the application, an information of the application (e.g., traffic filter, application identifier, application name). The fifth node may store information received via the Nnef MSG5 in a fourth node (e.g., UDM, UDR, HSS) and/or may send the information to a second node (e.g., SMF, PGW, SGW) and/or a third node (e.g., PCF, PCRF) and/or a first node (e.g., MME, AMF). In other example, the fourth node may send the information to the second node and/or the first node. In an example, the third node may send the information to the second node and/or the first node. In an example, a node (e.g., the fourth node, the fifth node, the second node, the third node, the first node) may send the information to the UE. For example, the third node may receive the information. For example, the third node may determine whether to allows the UE to use the S&F mode and/or may update the uplink time requirement. The third node may send to the UE, a policy container. The policy container may comprise the uplink time requirement and/or the allowance of the S&F mode.

In an example, the UE may the received uplink time requirement and/or allowance of the S&F mode. The UE may use the received uplink time requirement. For example, as shown in the previous example, the UE may determine, based on the S&F link availability information and/or the received uplink time requirement, whether a uplink data packet of the application can be delivered, meeting QoS. For example, if the uplink time requirement indicates 5 hours, and if the link availability information indicates that the uplink data packet can be delivered in 4 hours, the UE may send the uplink data packet.

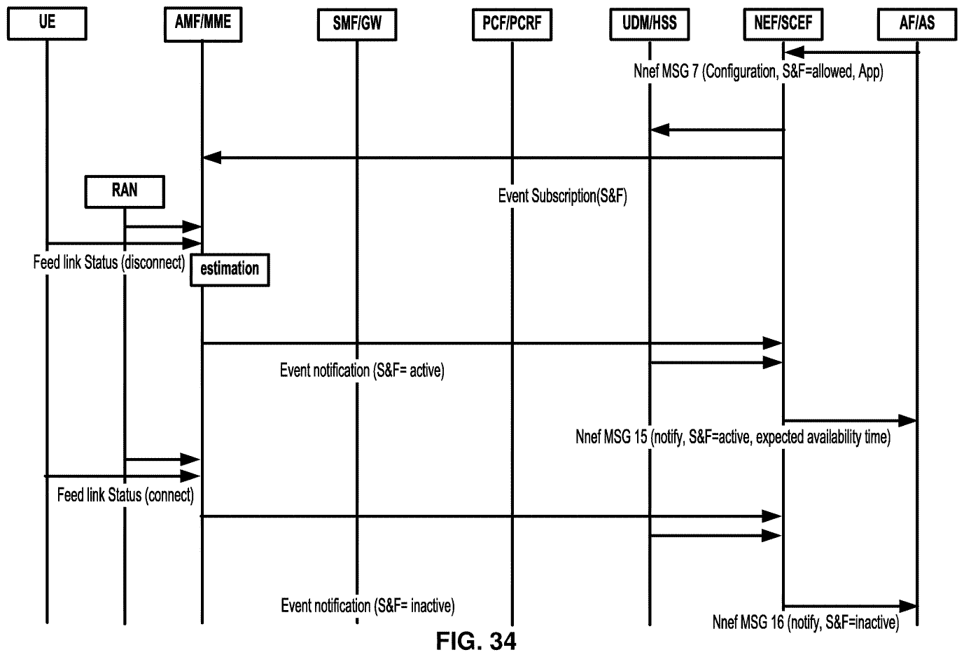

FIG. 34 depicts one example embodiment of the present disclosure. In an example, an application server of an application may subscribe to an event notification, e.g., indicating time related event. This may assist for the application server to determine when to send a downlink data packet, reducing time out. For brevity, based on the other part of the present disclosure, redundant details will be omitted.

In an example, the application server may send to a fifth node (e.g., NEF, SCEF), a Nnef MSG 7. The Nnef MSG 7 may comprise at least one of a S&F (SF) configuration, the indication of whether the SF mode is allowed for the application, the information of the application (e.g., traffic filter, application identifier, application name). For example, the SF configuration may indicate whether the application server request an SF event notification. The fifth node may store information (e.g., the SF configuration, the indication of whether the SF mode is allowed for the application, the information of the application) in a UDM/HSS. In an example, the information may be sent as an event subscription request. For example, the event subscription request message may comprise one or more events requested to be notified. For example, when an event of the one or more events occurs, the event may be notified. For example, the SF configuration may comprise the one or more events and/or the SF configuration may request to report the one or more events. For example, the one or more events may comprise at least one of a first event of a feeder link (e.g., when the feeder link becomes available/unavailable for the wireless device), a second event of a service link (e.g., when the service link becomes available/unavailable for the wireless device), a third event of the SF mode (e.g., when a downlink data packet (and/or a uplink data packet) is stored in a network, when the SF mode is applied for the downlink data packet (and/or a uplink data packet), whether the SF mode is used for the wireless device, whether the SF mode is activated for the wireless device, whether the downlink data packet for the SF mode is discarded (expired), whether delivery via the SF mode fails (or succeeds), and/or the like), an estimation of the SF mode (e.g., when a data packet is expected to be delivered) and/or the like.

In an example, the estimation may be made using the SF link availability information, e.g., when the feeder link becomes unavailable, when the feeder link becomes (or expected to be) unavailable. For example, when the estimation is available and/or when the at least one event occurs, the fifth node may receive an event notification. For example, when the feeder link is available and/or when the SF mode is not used, the event notification may indicate that the feeder link is available and/or that the SF mode is not used. For example, when the feeder link is not available and/or when the SF mode is used, the event notification may indicate that the feeder link is not available and/or that the SF mode is used, and/or when the SF link is available and/or an amount of time for data delivery. This may help the application server to adjust when to send the downlink data packet and/or may assist each node whether to perform buffering or not.

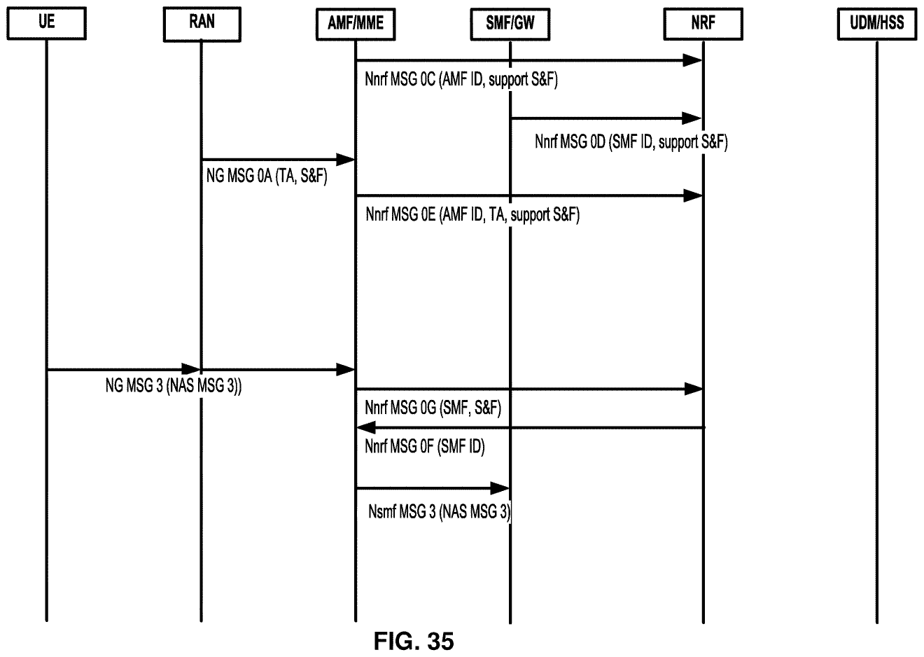

FIG. 35 depicts one example embodiment of the present disclosure. In an example, a node may perform indicate whether the node supports a feature of SF mode. This may assist for using the node to support the SF mode. For brevity, based on the other part of the present disclosure, redundant details will be omitted.

In an example, a first node (e.g., MME, AMF) may send a Nnrf MSG 0C message (e.g., Nnrf service request, NF registration request) to a sixth node (e.g., NRF, OAM), for registration of the first node. For example, the first node may register the first node to the sixth node, to provide one or more first node services to one or more network nodes. For example, the Nnrf MSG 0C message may be a first Nnrf_NFManagement_NFRegister request message. For example, the Nnrf MSG 0C message may comprise at least one of a first type of network node, a first instance ID, a first IP address, one or more first supported services, and so on. For example, the first type of network node may indicate that a type of the network node is mobile management node. For example, the first instance ID may indicate an identity of the first node (e.g., AMF ID 1). For example, the one or more first supported services may indicate one or more first services provided by the first node and/or one or more first capabilities of the first node. For example, the one or more first capabilities may indicate that the first node supports the feature of SF mode. Based on that the first node supports the feature of the SF mode, the one or more first supported services may indicate that the first node supports the feature of the SF mode. The sixth node may receive the Nnrf MSG 0C message, and/or may store the information delivered by the Nnrf MSG OC message. In response to the received Nnrf MSG 0C message, the sixth node may send to the first node, a Nnrf MSG 0C response message (e.g., Nnrf_NFManagement_NFRegister response message) indicating successful registration of the first node. Similar steps may be performed by the second node (e.g., SMF, PGW, SGW), the third node and/or the fourth node to the sixth node.

In an example, the UE may send the NAS MSG 3 to the first node. In an example, based on that the NAS MSG 3 indicates support of the feature of the SF mode, and/or based on that the RAN uses the SF mode, the first node may send a Nnrf MSG 1 message (e.g., Nnrf_NFDiscovery Request message), to the NRF. For example, because the UE requests the dualsteer policy and/or because the UE supports the feature of the dualsteer, the AMF 1 may send the Nnrf MSG 1. For example, the Nnrf MSG 1 may indicate that an information of a PCF supporting the dualsteer is requested. For example, the Nnrf MSG 1 may indicate that a type of the target network node is PCF and/or that the target network node supports the feature of the dualsteer.

In an example, the NRF may receive the Nnrf MSG 0G message. For example, the Nnrf MSG 0G may comprise indication of a type (e.g., SMF, PGW, SGW) of the second node, and/or indication of supporting the feature of the SF mode. In response to receiving the Nnrf MSG 0G message, the NRF may send a Nnrf MSG 0F message to the first node. For example, the Nnrf MSG 0F message may be Nnrf_NFDiscovery Response message. Because the Nnrf MSG 0G requests information of the second node supporting the feature of SF mode, the Nnrf MSG 0F message may comprise information of one or more second nodes supporting the feature of the SF mode. For example, the NRF may use stored information, to determine which second nodes support the feature of SF mode. For example, the information of the one or more second nodes may indicate an IP address of the second nodes, an identifier of the second node, the one or more first capabilities of the second nodes, the one or more first supported services, and/or the like. This may prevent the first node in selecting the second node which does not supporting the SF mode. In other example, the first node may use local configuration (e.g., locally stored) to select the second node. For example, the first node may send to the second node (indicated by the Nnrf MSG 0F), the Nsmf MSG 3.

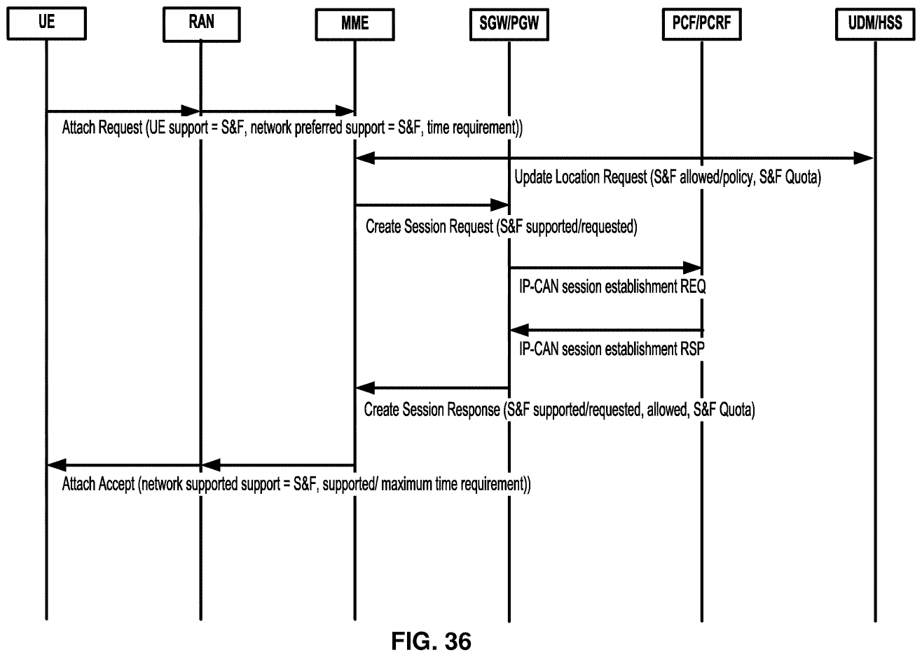

FIG. 36 depicts one example embodiment of the present disclosure. In an example, a UE may perform registration via MME, and/or a network may use the MME, a S-GW, a P-GW, a PCRF, a HSS and/or the like. For example, in case of one or more EPS network node is used, similar behavior as described in previous figures may be used. For brevity, based on the other part of the present disclosure, redundant details will be omitted.

In an example, a UE may send an attach request to MME via an eNB (or, an en-gNB). For example, the attach request may indicate that the UE supports the SF mode, that the UE prefers a network supporting the SF mode, and/or the uplink time requirement for the SF mode.

In an example, the MME may send to a HSS, a update location request message and may receive from the HSS, a update location acknowledge message. For example, the update location acknowledge message may indicate whether the UE is allowed for the SF mode, a subscription information of the SF mode, and/or the like. The update location acknowledge message may assist the MME to determine the SF configuration.

In an example, the MME may send to a SGW (and/or S-GW, P-GW, PGW) a create session request message. For example, the create session request message may indicate whether the UE supports the SF mode, whether the MME supports the SF mode, whether the SF mode is allowed, and/or the like.

In an example, the SGW may receive the create session request message. In an example, the SGW may send to a PCRF, IP-CAN session establishment request. For example, the IP-CAN session establishment request message may indicate whether the UE supports the SF mode, whether the MME supports the SF mode, whether the SF mode is allowed, and/or the like. For example, based on that the UE supports the SF mode, the PCRF may determine whether to allow the SF mode. For example, the PCRF may send to the SGW, IP-CAN session establishment response. For example, the IP-CAN session establishment response may indicate whether the SF mode is allowed, a data quota for the SF mode, and/or the like.

In an example, the SGW may send to the MME, Create session response message. For example, the create session response message may indicate one or more QoS parameters, whether the SF mode is used/allowed and/or the like.

In an example, the MME may send to the UE, an attach accept message (and/or PDN connectivity accept message, and/or the like. For example, the attach accept message may indicate whether the network supports the SF mode, a supported maximum packet delay budget for uplink for SF mode, a supported maximum packet delay budget for downlink for SF mode, and/or the like.

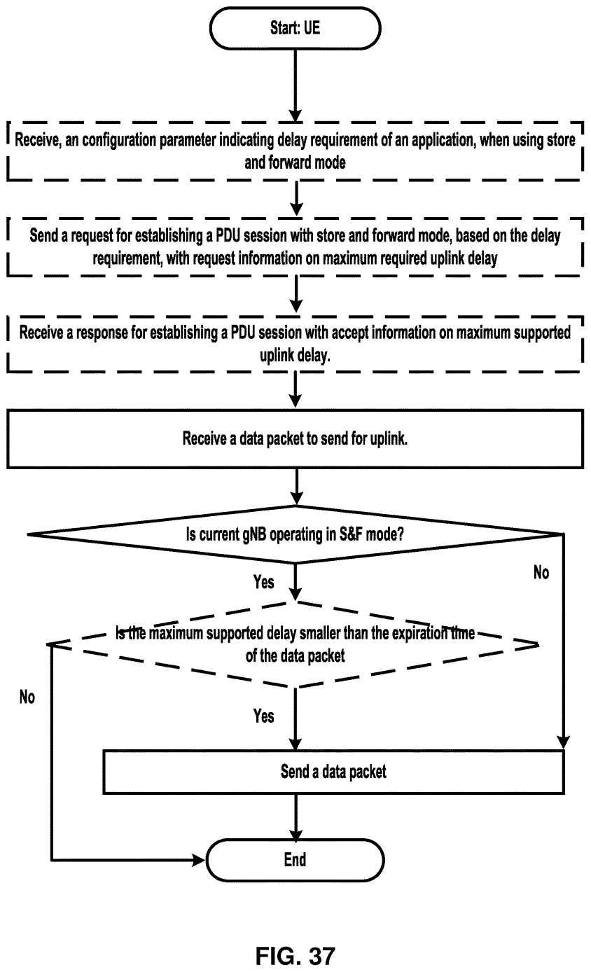

FIG. 37 depicts one example embodiment of the present disclosure.

In an example, a UE may receive, a configuration parameter indicating delay (packet delay/time budget) requirement of an application, for a store and forward (SF, S&F) mode. For example, the parameter may indicate a first parameter for uplink and/or as second parameter for downlink. In an example, the UE may send a registration request (or Attach request) indicating registration for the SF mode. In an example, the UE may send a PDU session (or PDN connection) establishment request message of the SF mode. For example, the PDU session establishment request message may comprises a delay requirement information. For example, the delay requirement information may the configuration parameter. In an example, the UE may receive a PDU session establishment accept message comprising indication of maximum supported time delay (e.g., for uplink and/or for downlink). In an example, the UE may receive from an application, an uplink data packet. For example, the UE may determine whether a RAN (e.g., eNB, gNB) operates in the SF mode. If the RAN operates in the SF mode, the UE may determine whether the maximum supported time delay is smaller than the delay requirement. If the maximum supported time delay is smaller than the delay requirement of the application, the UE may send the uplink data packet to the RAN.

In an example, a UE (e.g., a wireless device) may receive from a base station, a message indicating establishment of a protocol data unit (PDU) session supporting a store and forward (SF) mode. In an example, the UE may send to the base station and based on the SF mode, a radio resource control (RRC) message. In an example, the RRC message may comprise a non-access stratum (NAS) message. In an example, the NAS message may comprise an uplink data packet of the PDU session and/or a time threshold information, of the uplink data packet, associated with the SF mode.

In an example, a UE (e.g., a wireless device) may send to a base station (e.g., eNB, gNB, a NTN RAN, and/or the like), an uplink data packet and a time information of the uplink data packet. For example, the uplink data packet may be of a PDU session. For example, the time information may be associated with a store and forward (SF) mode. For example, the PDU session may be of the SF mode.

In an example, the UE may receive an information indicating one or more feeder links for which the UE is allowed to use, indication of whether the UE is allowed to use the SF mode, and/or the like.

In an example, the UE may send to a mobility management node (e.g., AMF, MME), a registration request message (e.g., a message for registration, attach request). The registration request message may comprise at least one of a first indication indicating a preferred network behavior being the SF mode (e.g., a network supporting/operating the SF mode) or a second indication indicating the wireless device supporting the SF mode. In an example, in response to sending the registration request message, the UE may receive a registration accept message. For example, the registration accept message may indicate a supported network behavior being the SF mode (e.g., the network supports the SF mode, the UE is allowed to use the SF mode).

In an example, the UE may send, a request message requesting establishment of the PDU session, wherein the request message further comprises a first uplink packet delay budget for the PDU session. For example, the UE may send the request message indicating establishment of the PDU session, after receiving the registration accept message.

In an example, the UE may receive from the base station, a message indicating establishment of the PDU session supporting the SF mode. For example, the UE may send the uplink data packet after receiving the message. For example, the message may indicate a second uplink packet delay budget. For example, the second uplink packet delay budget may a delay budget supported (provided) by a network in the SF mode and/or may be a maximum packet delay for the PDU session.

In an example, the UE may receive from the base station, a first radio resource control (RRC) message indicating the SF mode. In an example, the first RRC message may further comprise a link schedule information. For example, the link schedule information comprises at least one of:
one or more service link schedule information. For example, each of the one or more service link schedule information indicating at least one of a service link identifier indicating a service link, one or more first areas where the service link is available to the wireless device, and/or one or more first periods when the service link is available to the wireless device.
one or more feeder link schedule information. For example, each of the one or more feeder link schedule information indicating at least one of a feeder link identifier indicating a feeder link, one or more second areas where the feeder link connects to, and/or one or more second periods when the feeder link is available.

In an example, the UE may select, based on the link schedule information, at least one of a first service link and/or a first feeder link. In an example, the UE may determine and based on the link schedule information, that the uplink packet can be delivered within an uplink packet delay budget (e.g., uplink data packet delay budget requirement). For example, the uplink packet delay budget may be at least one of the first uplink packet delay budget and/or the second uplink packet delay budget. Alternatively and/or additionally, the UE may determine and based on the link schedule information, that a third uplink data packet cannot be delivered within the uplink packet delay budget and/or may not send the third uplink data packet to the base station.

In an example, the UE may send the uplink data packet after receiving the first RRC message. In an example, the UE may send an RRC message comprising a NAS message and/or the time information. For example, the NAS message may comprise the uplink data packet. For example, the UE may send the time information (e.g., the SF time information), if the UE receives the first RRC message indicating the SF mode. Alternatively, the UE may send a third RRC message. For example, the third RRC message may comprise a second NAS message. For example, the second NAS message may comprise a second uplink data packet. For example, the third RRC message may not comprise a second time information, if the UE receives a 11st RRC message indicating the SF mode not being used (activated).

For example, the RRC message may further comprise an information of the first service link and/or the first feeder link, selected by the UE.

In an example, the time information indicates at least one of a first time value indicating a first time when the uplink data packet is generated, a second time value indicating a second time being passed since the uplink packet is generated, a third time value indicting a third time when the uplink data packet expires, a fourth time value indicating a fourth time from when the uplink data packet is not value, and/or a fifth time value indicating a fifth time remaining for delivery.

For example, the RRC message may further comprise a location information indicating where the uplink data packet is generated or transmitted.

For example, the RRC message may further comprise an information of the first service link and/or the first feeder link.

In an example, the UE may further receive, a timer value for a timer for the SF mode. For example, the UE may start the timer with the timer value when the UE receives a fifth uplink data packet from the application. For example, the UE may stop the timer when the UE transmits the fifth uplink data packet to the base station. For example, the UE may send the fifth uplink data packet while the timer is running. For example, the UE may discard the fifth uplink data packet when the timer expires.

In an example, a wireless device (UE) may send to an access and mobility control function (AMF) of a network, a registration request message indicating the wireless device supporting a store and forward (SF) mode. The wireless device may receive from the AMF, a registration accept message indicating the SF mode being supported by the network. The wireless device may send to a session management function (SMF) of the network, a request message requesting establishment of a protocol data unit (PDU) session of the SF mode, wherein the request message indicates an uplink delivery time requirement of the PDU session. The wireless device may receive from the SMF, a response message indicating accept of the PDU session. The wireless device may send to a base station of the SF mode, a packet of the PDU session,

In an example, a wireless device may receive from a network, a registration accept message indicating that a store and forward (SF) mode is supported. The wireless device may send to the network, a request message requesting establishment of a protocol data unit (PDU) session of the SF mode, wherein the request message indicates an uplink time requirement of the PDU session.

In an example, a wireless device may send, a request message requesting establishment of a protocol data unit (PDU), wherein the request message indicates an uplink time requirement of the PDU session.

In an example, a wireless device may send to a base station, a RRC message indicating a feeder link selected by the wireless device for a SF mode.

In an example, a wireless device may send to a base station, a RRC message indicating a service link selected by the wireless device for a SF mode.

In an example, a wireless device may receive from a base station, a RRC message indicating one or more feeder links provided by the base station. For example, for each of the one or more feeder links, the RRC message may indicate at least one of a time period when the each is available, where the each is available, a country for the each, a network for the each, and/or the like.

In an example, a wireless device may send to a base station of a SF mode, a RRC message indicating one or more data packet to transmit.

In an example, a wireless device may send to a SMF, a uplink time requirement for a protocol data unit session.

In an example, a wireless device may send to a base station, a NAS message indicating whether the UE supports a SF mode.

In an example, a wireless device may send to a base station, a NAS message indicating a preferred network being supporting a SF mode.

In an example, a wireless device may receive from a base station, a NAS message indicating a packet delay requirement for an uplink data packet for a SF mode.

In an example described above, the UE may receive from a RAN, a configuration indicating whether the UE needs to include time information (e.g., SF time information) in the RRC message. For example, if the RAN configures the UE to send the time information, the UE may include the time information in the RRC message used for transmitting the uplink data packet. For example, if the RAN does not configure the UE to send the time information, the UE may not include the time information in the RRC message used for transmitting the uplink data packet.

In an example described above, the UE may receive from a core network node, a configuration indicating whether the UE needs to include time information (e.g., SF time information) in the NAS message. For example, if the core network node configures the UE to send the time information, the UE may include the time information in the NAS message used for transmitting the uplink data packet. For example, if the core network node does not configure the UE to send the time information, the UE may not include the time information in the NAS message used for transmitting the uplink data packet.

In an example described above, data packet delivery via control plane (e.g., control plane optimization) is used as examples. Similar, enhanced may be applicable to delivery via user plane (e.g., user plane optimization). For example, in a PDU (e.g., SDAP PDU, PDCP PDU, RLC PDU, PDU header), the time information can be added. For example, a field in a header (e.g., SDAP header, PDCP header, RLC header, MAC header) may indicate whether the PDU comprises the time information.

In an example described above, a feeder link is available if a satellite of the feeder link can exchange a signal with an earth station of the feeder link. For example, if the signal transmitted by the satellite cannot be received by the earth station (e.g., due to out of line of sight), it may mean that the feeder link is not available. For example, if the signal transmitted by the satellite can be received by the earth station (e.g., due to in line of sight), it may mean that the feeder link is available.

In some aspects, the techniques described herein relate to a method including: sending, by a wireless device to a network, a first message requesting registration, indicating that the wireless device supports a store and forward (SF) mode; receiving, by the wireless device, a second message accepting registration, indicating the SF mode being supported by the network; sending, by the wireless device, a request message requesting establishment of data session of the SF mode, wherein the request message indicates an uplink delivery time requirement for the SF mode; and receiving, by the wireless device, a response message indicating establishment of the data session; and sending, by the wireless device, a packet of the data session,

In some aspects, the techniques described herein relate to a method including: sending, by a wireless device to a network, a request message requesting establishment of a data session of a store and forward (SF) mode, wherein the request message indicates an uplink time requirement of the data session.

In some aspects, the techniques described herein relate to a method, further including receiving by the wireless device from the network, a message indicating that the network supports the SF mode.

In some aspects, the techniques described herein relate to a method including: receiving, by a first node from a second node, one or more messages indicating at least one of: a service link availability information indicating one or more time period when a service link is available, wherein the service link is an interface between the wireless device and a first network node on a satellite; and a feeder link availability information indicating one or more time period when a feeder link is available, wherein the feeder link is an interface between the first network node on a satellite and a second network node on a ground.

In some aspects, the techniques described herein relate to a method including: receiving, by a first node from a second node, one or more messages including: a first configuration parameter indicating one or more feeder links, wherein the feeder link is an interface between a first network node on a satellite and a second network node on a ground; and a second configuration indicating one or more conditions, wherein the wireless device is allowed to use a feeder link of the one or more feeder links, if the one or more conditions are met.

In some aspects, the techniques described herein relate to a method including: receiving, by a first network node from a wireless device, one or more messages requesting registration of the wireless device; receiving, by the first network node from a second network node, an information indicating whether the wireless device is allowed for a store and forward (SF) mode; and sending, by the first network node and based on the information that the SF mode is allowed, a message accepting the registration.

In some aspects, the techniques described herein relate to a method, wherein the first network node is at least one of a mobility management entity (MME) and a packet gateway (PGW), and a second network node is at least one of a home subscriber server (HSS) or a policy and charging rule function (PCRF).

In some aspects, the techniques described herein relate to a method, wherein the information is at least one of a subscription information and a policy information.

In some aspects, the techniques described herein relate to a method, wherein the information indicates at least one of one or more time periods when the SF mode is allowed and one or more locations where the SF mode is allowed.

In some aspects, the techniques described herein relate to a method, wherein the first network node sends to the second network node, a request message requesting the information, and the request message further includes at least one of a first indication indicating whether the first network node supports the SF mode and a second indication indicating that the first network node operates in the SF mode.

In some aspects, the techniques described herein relate to a method including: sending, by a first network node to a second network node, one or more second message including at least one of:-a first information indicating whether a store and forward (SF) mode is used for a wireless device;-a second information indicating a time when a downlink data can be delivered to the wireless device;-a third information indicating when a feeder link is available;-a fourth information indicating when a service link to the wireless device is available;—a fifth information indicating discard of data packet for the wireless device in the SF mode;—a sixth information indicating buffering of a data packet due to the SF mode;—a seventh information indicating whether the wireless device is allowed to use store and forward (SF) mode; and—a eighth information indicating when the wireless is allowed to use the SF mode or where the wireless device is allowed to use the SF mode.

In some aspects, the techniques described herein relate to a method, further including receiving by the first network node from the second network node, one or more first messages requesting a notification of information associated with the wireless device.

In some aspects, the techniques described herein relate to a method, wherein the one or more first messages further include a quality of service requirement for a data session configured with the SF mode, indicating at least one of a maximum time budget allowed for a data packet of the data session, a maximum allowed buffering time.

In some aspects, the techniques described herein relate to a method, further including receiving by the first network node, a message requesting a data delivery, wherein the message includes at least one of an indication of the SF mode, a data packet, a location where the data packet is received from the wireless device, a location where the data packet is transmitted to the wireless device, an indication indicating whether the data packet is received in the SF mode, a time spent in delivering the data packet.

In some aspects, the techniques described herein relate to a method including: sending, by a first network node to a second network node, one or more messages indicating: that the first network operates in a store and forward (SF) mode; that a wireless device uses the SF mode; information of a radio access network operating in the SF mode; and an uplink data packet.

In some aspects, the techniques described herein relate to a method including: receiving, by a first network node, a downlink packet for a wireless device, wherein the wireless device is in a store and forward mode; determining, by the first network node, whether a quality of service requirement for the downlink packet can be met, based on:-availability of a service link and a feeder link; and -the quality of service requirement; and sending, by the first network node to a second network node and based on the determining, the downlink packet.

In some aspects, the techniques described herein relate to a method including: receiving, by a first network node from a second network node, one or more messages including a policy parameter for a store and forward mode, wherein the policy parameter indicates one or more feeder links allowed for a wireless device.

In some aspects, the techniques described herein relate to a method, wherein the policy parameter includes one or more identifiers of the one or more feeder links.

In some aspects, the techniques described herein relate to a method, wherein the policy parameter includes one or more time periods during which the wireless device is allowed to use the one or more feeder links.

In some aspects, the techniques described herein relate to a method, wherein the policy parameter includes one or more areas where the wireless device is allowed to use the one or more feeder links.

In some aspects, the techniques described herein relate to a method including: receiving, by a wireless device, one or more messages including a policy parameter for a store and forward mode, wherein the policy parameter indicates one or more feeder links allowed for a wireless device; and sending, by the wireless device, an uplink data packet, via the one or more feeder links.

In some aspects, the techniques described herein relate to a method including: receiving, by a first network node from a second node, a message including one or more parameters, wherein the one or more parameters indicate whether a wireless device is allowed to send a data via a network operating in a store and forward (SF) mode.

In some aspects, the techniques described herein relate to a method, wherein the message further includes policy parameter includes one or more areas where the wireless device is allowed to use the one or more feeder links.

In some aspects, the techniques described herein relate to a method, further including receiving a data for the wireless device, operating in the SF mode.

In some aspects, the techniques described herein relate to a method, wherein the first network node sends, an indication that the data is discarded, based on that the wireless device operating in the SF mode.

In some aspects, the techniques described herein relate to a method, wherein the first network node sends, an indication that the data is received from the wireless device operating in the SF mode.

In some aspects, the techniques described herein relate to a method, further including sending by the first network node, a report indicating that a data packet is buffer for the wireless device, due to the wireless device being in the SF mode.

In some aspects, the techniques described herein relate to a method, wherein the report is a charging record.

In some aspects, the techniques described herein relate to a method, wherein the charging record includes an information of location where the data is received or transmitted.

In some aspects, the techniques described herein relate to a method, further including determining by the first network node, whether the data can be delivered, meeting a service requirement of the SF mode.

In some aspects, the techniques described herein relate to a method and 55, wherein the first network node delivers the data, based on the determining.

In some aspects, the techniques described herein relate to a method and 55, wherein the first network node sends information indicating at least one of whether the data is received in the SF mode, a time information of the data, and a location information of where the data is received.

In some aspects, the techniques described herein relate to a method, wherein the time information indicates at least one of when the data is generated, when the data is received, remaining time budget of the data, expiration time of the data, maximum delay of the data, amount of time used for delivery of the data.

What is claimed is:

1. A wireless device comprising:
one or more processors; and
memory storing instructions that, when executed by the one or more processors, cause the wireless device to:
send, to a base station on a satellite, a first message comprising a capability parameter indicating that the wireless device supports a store and forward (SF) mode;
receive one or more second messages comprising:
a feeder link information indicating a period when a feeder link of the satellite is available;
a second parameter indicating that a network operates in the SF mode; and
a third parameter indicating a supported time delay of an uplink data packet sent in the SF mode; and
send, to the base station and after receiving the one or more second messages, one or more third messages comprising:
a first uplink data packet sent in the SF mode; and
a validity time information associated with the first uplink data packet sent in the SF mode.

2. The wireless device of claim 1, wherein the supported time delay comprises a maximum packet delay provided, for the SF mode, from the wireless device to a gateway of the network.

3. The wireless device of claim 1, wherein the one or more second messages further comprise one or more information comprising at least one of:
one or more service link schedule information, wherein each of the one or more service link schedule information indicates at least one of:
a service link identifier indicating a service link;
one or more first areas where the service link is available; or
one or more first periods when the service link is available to the wireless device; or
one or more feeder link schedule information, wherein each of the one or more feeder link schedule information indicating at least one of:
one or more second areas where the feeder link connects to; or
one or more second periods when the feeder link is available.

4. The wireless device of claim 3, wherein the instructions further cause the wireless device to select, based on the one or more information, at least one of a first service link or a first feeder link.

5. The wireless device of claim 3, wherein the instructions further cause the wireless device to determine, by the wireless device and based on the one or more second messages, that a third uplink data packet cannot be delivered within a requirement for an uplink data packet, and wherein the instructions does not further cause the wireless device to transmit, by the wireless device, the third uplink data packet based on the determining.

6. The wireless device of claim 1, wherein the one or more second messages further comprise information indicating one or more allowed feeder links for which the wireless device is allowed to use.

7. The wireless device of claim 1, wherein the one or more second messages further comprise a timer value for a timer for the SF mode.

8. The wireless device of claim 7, wherein the instructions further cause the wireless device to start the timer in response to the wireless device being caused by the instructions to receive the first uplink data packet from an application layer, stop the timer in response to the wireless device being caused by the instructions to send the first uplink data packet, and discard the first uplink data packet in response to expiry of the timer.

9. The wireless device of claim 1, wherein the instructions further cause the wireless device to receive, from a base station, a system information block (SIB) message indicating that a network operates in the SF mode.

10. The wireless device of claim 1, wherein the one or more second messages are received from a network node managing mobility management, and the one or more second messages indicate whether a data session, via which the first uplink data packet is sent, is configured with the SF mode.

11. The wireless device of claim 10, wherein:
the data session is established based on the wireless device being further caused by the instructions to send a request message requesting establishment of the data session; and
the request message indicates a time delay budget requirement for at least one of downlink or uplink.

12. The wireless device of claim 1, wherein the validity time information indicates:
a first time value indicating a first time when the first uplink data packet is generated; and
at least one of:
a second time value indicating a second time elapsed since the first uplink data packet is generated;
a third time value indicating a third time when the first uplink data packet expires;
a fourth time value indicating a fourth time from when the first uplink data packet is invalid; or
a fifth time value indicating a fifth time remaining for delivery.

13. The wireless device of claim 1, wherein the one or more third messages further comprise a location information indicating where the first uplink data packet is generated or transmitted.

14. A base station on a satellite comprising:
one or more processors; and
memory storing instructions that, when executed by the one or more processors, cause the base station to:
receive, from a wireless device, a first message comprising a capability parameter indicating that the wireless device supports a store and forward (SF) mode;
send, to the wireless device, one or more second messages comprising:
a feeder link information indicating a period when a feeder link of the satellite is available;
a second parameter indicating that a network operates in the SF mode; and
a third parameter indicating a supported time delay of an uplink data packet sent in the SF mode; and
receive, from the wireless device, one or more third messages comprising:
a first uplink data packet sent in the SF mode; and
a validity time information associated with the first uplink data packet sent in the SF mode.

15. The base station of claim 14, wherein the one or more second messages further comprise one or more information comprising at least one of:
one or more service link schedule information, wherein each of the one or more service link schedule information indicates at least one of:
a service link identifier indicating a service link;
one or more first areas where the service link is available; or
one or more first periods when the service link is available to the wireless device; or
one or more feeder link schedule information, wherein each of the one or more feeder link schedule information indicating at least one of:
one or more second areas where the feeder link connects to; or
one or more second periods when the feeder link is available.

16. The base station of claim 14, wherein the one or more second messages further comprise information indicating one or more allowed feeder links for which the wireless device is allowed to use.

17. The base station of claim 14, wherein the instructions further cause the base station to start a time duration for the SF mode in response to the base station being caused by the instructions to receive the first uplink data packet from the wireless device, and discard the first uplink data packet in response to the base station not being caused by the instructions to send the first uplink data packet within the time duration.

18. The base station of claim 14, wherein the instructions further cause the base station to send, to the wireless device, a system information block (SIB) message indicating that a network operates in the SF mode.

19. The base station of claim 14, wherein the one or more second messages are sent from a network node managing mobility management, and the one or more second messages indicate whether a data session, via which the first uplink data packet is sent, is configured with the SF mode, and wherein:
the data session is established based on the base station receiving a request message requesting establishment of the data session; and
the request message indicates a time delay budget requirement for at least one of downlink or uplink.

20. The base station of claim 14, wherein the validity time information indicates:
a first time value indicating a first time when the first uplink data packet is generated; and
at least one of:
a second time value indicating a second time elapsed since the first uplink data packet is generated;
a third time value indicating a third time when the first uplink data packet expires;
a fourth time value indicating a fourth time from when the first uplink data packet is invalid; or
a fifth time value indicating a fifth time remaining for delivery.
